(19) United States
(12) Patent Application Publication
(10) Pub. No.: US 2025/0196102 A1
(43) Pub. Date: Jun. 19, 2025

(54) MICROWAVE BASED CARBON CAPTURE THROUGH FLUIDIZED BED REACTORS

(71) Applicant: THE BOARD OF TRUSTEES OF THE UNIVERSITY OF ALABAMA, Tuscaloosa, AL (US)

(72) Inventors: Shahriar AMINI, Tuscaloosa, AL (US); Mustafa ERGUVAN, Tuscaloosa, AL (US)

(21) Appl. No.: 18/980,474

(22) Filed: Dec. 13, 2024

Related U.S. Application Data
(60) Provisional application No. 63/610,149, filed on Dec. 14, 2023.

(51) Int. Cl. B01J 20/34; B01D 53/12; B01J 20/18; B01J 20/28

(52) U.S. Cl. CPC B01J 20/3441; B01D 53/12; B01J 20/18; B01J 20/28004; B01J 20/28016; B01J 20/3408; B01D 2253/108; B01D 2257/504; B01D 2258/06; B01D 2259/40094

(57) ABSTRACT

Provided is a method of carbon capture, the method comprising: a) providing a solid sorbent in a fluidized bed reactor; b) fluidizing the solid sorbent by flowing air comprising CO₂ through the fluidized bed reactor, wherein at least a portion of the CO₂ is adsorbed onto the solid sorbent; and c) refluidizing the solid sorbent having CO₂ adsorbed thereon by flowing an inert fluid through the fluidized bed reactor; and d) irradiating the fluidized solid sorbent having CO₂ adsorbed thereon with microwave irradiation, thereby desorbing at least a portion of the captured composition from the fluidized solid sorbent.

### CROSS-REFERENCE TO RELATED APPLICATIONS

This application claims the benefit of priority to U.S. Provisional Application No. 63/610,149, filed Dec. 14, 2023, which is incorporated by reference herein in its entirety.

### BACKGROUND

Carbon dioxide (CO₂) is claimed to be the largest greenhouse gas contributor to climate change and global warming, with global CO₂ emission levels of 36 GT/yr (Kolle, J. M. et al., 2021) (Houghton, J., 2015). As the CO₂ level in the atmosphere increased 40% in the last two centuries, a report in The Intergovernmental Panel on Climate Change stated that the CO₂ emissions need to be reduced by 41-72% by 2050 in order keep global temperature increase under 2° C. (IEA, 2016) (Change, I. C., 2014) (Yassin, M. M., et al., Journal of Environmental Chemical Engineering, 2021). Carbon Capture, Storage and Utilization (CCUS) methods have been one of the most effective ways to combat greenhouse gas emissions (McGurk, S. J., et al., 2017). Among different CO₂ capture technologies, the most advanced and commercially available technology is the liquid amine scrubbing process, though it has several disadvantages such as significant energy consumption, high corrosion, high solvent losses and degradation (Yassin, M. M., et al., Journal of Environmental Chemical Engineering, 2021) (Meloni, E., et al., 2021). As an alternative to liquid absorbents, an adsorption-based approach using solid sorbents can eliminate the drawbacks of amine-based aqueous solvents due to its simplicity, high efficiency, and low energy requirement (Meloni, E., et al., 2021) (Ellison, C. et al., 2021). Several different adsorbents such as zeolite, silica gel, activated carbon, and metal organic frameworks have been tested for CO₂ capture, which have all shown high CO₂ adsorption capacity (Hauchhum, L. et al., 2014) (Pal, A., et al., 2016) (Wang, H., et al., 2014).

There are two different desorption methods in adsorption-based carbon capture technologies: pressure or temperature swing processes. In a conventional temperature swing adsorption (TSA) process, the sorbent is heated by either passing a heated inert gas or heating the regenerator column with repetitive heating elements. The energetic efficiency of both methods is quite low due to the heat losses and considerable energy required to heat inert gases (Ellison, C. et al., 2021).

As such, there is a need for improved and more energy efficient methods of carbon capture, especially desorption. These needs and others are at least partially satisfied by the present disclosure.

### SUMMARY

Microwave heating can be used for CO₂ regeneration to minimize heat losses and speed up the desorption processes. It uses less energy compared to conventional thermal heating since it can heat the sorbent directly without heating the reactor walls. As opposed to conventional heating, microwave irradiation can heat the sorbent via direct molecular interactions with the electromagnetic radiation (dielectric and volumetric heating), which can eliminate heat transfer limitations. Furthermore, the heating rate using microwave irradiation is significantly higher than that of traditional heating, which could increase the energy efficiency, productivity, and cost-effectiveness of carbon capture processes.

Disclosed herein is a method for regenerating CO₂ from a solid sorbent (e.g., Zeolite 13X) using microwave irradiation under fluidization conditions. Volumetric heating using microwave irradiation can allow effective desorption of CO₂ from the sorbent, while fluidization can enhance the heat transfer within the sorbent by providing homogeneous heat transfer with lower desorption time and absorbed energy. Desorption time and energy consumption can be impacted by flow rate and regeneration temperature. Under different conditions, the energy consumption to regenerate a kg CO₂ can vary between about 2.5 MJ and 30 MJ. As such, fluidization plays a significant role in the desorption of CO₂, especially between the 90% and 100% regeneration percentages, and can reduce the overall energy consumption of CO₂ capture.

In an aspect, provided is a method of desorption, the method comprising irradiating a fluidized solid sorbent having a captured composition adsorbed thereon with microwave irradiation, thereby desorbing at least a portion of the captured composition from the fluidized solid sorbent.

In another aspect, provided is a method of carbon capture, the method comprising: a) providing a solid sorbent in a fluidized bed reactor; b) fluidizing the solid sorbent by flowing air comprising CO₂ through the fluidized bed reactor, wherein at least a portion of the CO₂ is adsorbed onto the solid sorbent; and c) refluidizing the solid sorbent having CO₂ adsorbed thereon by flowing an inert fluid through the fluidized bed reactor; and d) irradiating the fluidized solid sorbent having CO₂ adsorbed thereon with microwave irradiation, thereby desorbing at least a portion of the captured composition from the fluidized solid sorbent.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

FIG. 1 depicts an experimental setup diagram. Labeled components are as follows: (1) N₂ gas cylinder, (2) CO₂ gas cylinder, (3) filter, (4) N₂ mass flow controller, (5) CO₂ mass flow controller, (6) check valve, (7) pyrometer, (8) cavity, (9) extreme condition moisture trap and filter, (10) mass flow meter, (11) CO₂ sensor, (12) smart probe, (13) solid state microwave generator, (14) coaxial cable, (15) network hub.

FIG. 2 depicts an experimental setup according to the diagram of FIG. 1.

FIGS. 3A-3B depict temperature distribution in power tests for T set point mode (FIG. 3A) and manual mode (FIG. 3B).

FIG. 4 depicts power tests for T set point mode.

FIG. 5 depicts CO₂ concentration in the adsorption and desorption processes in cyclic experiments.

FIG. 6 depicts CO₂ concentration with time during adsorption for different flow rates.

FIGS. 7A-7B depict a comparison of CO₂ concentration and temperature profile during desorption stage with different power rates when the flow rate is 500 mL/min and target temperature is 40° C. (FIG. 7A) or 100° C. (FIG. 7B).

FIG. 8 depicts a forward and reflected power comparison along with desorption capacity and absorbed energy rate for different power and flow rates at 100° C. (P=Power (W), FR=Flow Rate (mL/min)).

FIG. 9 depicts forward and absorbed power comparison along with absorbed power ratio (P=Power (W), FR=Flow Rate (mL/min), TAP=Total Absorbed MW power (W)).

FIGS. 10A-10F depict a comparison of CO₂ concentration and temperature profile during desorption stage with different flow rates and microwave radiation powers. FIG. 10A shows 15 W and 40° C. FIG. 10B shows 15 W and 70° C. FIG. 10C shows 15 W and 100° C. FIG. 10D shows 30 W and 40° C. FIG. 10E shows 30 W and 70° C. FIG. 10F shows 30 W and 100° C.

FIG. 11 depicts a forward and absorbed power comparison along with desorption capacity and absorbed energy rate for different temperature and flow rates at 30 W. (T=Temperature (° C.), P=Power (W), FR=Flow Rate (mL/min)).

FIG. 12 depicts a forward and absorbed power comparison along with absorbed power ratio b) absorbed energy and desorption time for different power and flow rates. (FR=Flow Rate (mL/min), DT=Desorption Time(s), TAP=Total Absorbed MW power (W), Regeneration Temperature=100 C, MW Initial Power=30 W).

FIGS. 13A-13B depict a comparison of CO₂ concentration and temperature profile during desorption stage with different regeneration temperature when the flow rate is 200 mL/min (FIG. 13A) or 1000 mL/min (FIG. 13B).

FIG. 14 depicts a forward and absorbed power comparison along with desorption capacity and absorbed energy rate for different regeneration temperature, power, and flow rates. (T=Temperature (° C.), P=Power (W), FR=Flow Rate (mL/min)).

FIG. 15 depicts a forward and absorbed power comparison for different temperature and flow rates at 30 W (FR=Flow Rate (mL/min), T=Temperature (° C.) TAP=Total Absorbed MW power (W)).

FIGS. 16A-16B depict the effect of regeneration temperature on energy consumption (FIG. 16A) and on desorption time and absorbed power (FIG. 16B) for a complete desorption (Power=15 W, Flow Rate=750 Nml/min).

FIG. 17 depicts an experimental setup.

FIG. 18A depicts an experimental setup. FIG. 18B depicts the cavity. FIG. 18C depicts the inside of the cavity with the reactor. FIG. 18D depicts the cavity dimensions. FIG. 18E depicts the initial reactor bed height. FIG. 18F depicts the bed height during fluidization (750 mL/min)

FIGS. 19A-19B depict adsorption behaviors with time. FIG. 19A shows CO₂ concentration of the reactor outlet gas. FIG. 19B shows adsorption rate.

FIG. 20 depicts temperature control and monitoring on the microwave unit.

FIG. 21 depicts temperature distribution in the reactor under packed and fluidized bed conditions (temperature values are in ° C.).

FIG. 22 depicts transient average temperature of the quartz tube measured by pyrometer and IR camera.

FIGS. 23A-23B depict temperature and CO₂ variations with time for different initial power with the regeneration process at 100° C.

FIG. 24A depicts absorbed power distribution with time. FIG. 24B depicts absorbed power consumption for different initial powers with the regeneration process at 100° C.

FIG. 25 depicts Reflected Power (RF), Absorbed Power (AP), Energy Consumption (EC), and Desorption (DT) comparison for different MW initial powers at 100° C. regeneration temperature conditions.

FIGS. 26A-26B depict temperature and CO₂ variations with time for different initial power with the regeneration process at 33° C.

FIGS. 27A-27C depict a regeneration temperature of 33° C. FIG. 27A shows absorbed power change with time. FIG. 27B shows reflected power change with time. FIG. 27C shows total Reflected Power (RF), Absorbed Power (AP), Energy Consumption (EC), and Desorption (DT) comparison for different MW initial powers conditions.

FIGS. 28A-28H depict temperature and CO₂ variations with time for different initial power and regeneration temperatures. FIG. 28A shows temperature at 4 W. FIG. 28B shows CO₂ concentration at 4 W. FIG. 28C shows temperature at 8 W. FIG. 28D shows CO₂ concentration at 8 W. FIG. 28E shows temperature at 16 W. FIG. 28F shows CO₂ concentration at 16 W. FIG. 28G shows temperature at 30 W. FIG. 28H shows CO₂ concentration at 30 W.

FIG. 29 depicts desorption capacity and desorption time for different power and temperature conditions (T=Temperature (° C.), P=Power (W)).

FIG. 30 depicts energy consumption and desorption time under different temperature and initial microwave power conditions for 100% and 90% desorption efficiencies.

FIG. 31 depicts productivity comparison.

FIG. 32 depicts CO₂ regeneration ratio curves using Avrami's (Microwave Power=30 W), solid lines are fitted, dotted lines are experimental.

FIG. 33 depicts an Arrhenius plot and activation energy for desorption of CO₂.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Definitions

In this specification and in the claims that follow, reference will be made to a number of terms, which shall be defined to have the following meanings:

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

As used herein, the singular forms “a,” “an,” and “the” include plural referents unless the context clearly dictates otherwise. Thus, for example, reference to a “sorbent” includes aspects having two or more such sorbents unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

### Method

In an aspect, provided is a method of desorption, the method comprising irradiating a fluidized solid sorbent having a captured composition adsorbed thereon with microwave irradiation, thereby desorbing at least a portion of the captured composition from the fluidized solid sorbent.

In some aspects, the solid sorbent comprises zeolite, silica gel, activated carbon, a metal organic framework, or any combination thereof. In some aspects, the solid sorbent has a particle diameter of from about 175 μm to about 250 μm, or from about 185 μm to about 240 μm, or from about 195 μm to about 230 μm, or from about 205 μm to about 220 μm, or from about 175 μm to about 205 μm, or from about 185 μm to about 195 μm, or from about 220 μm to about 250 μm, or from about 230 μm to about 240 μm.

In some aspects, the captured composition comprises CO₂.

In some aspects, the method further comprises fluidizing the solid sorbent in a fluidized bed reactor by flowing an inert fluid through the fluidized bed reactor.

In some aspects, the inert fluid is a gas. In some aspects, the inert fluid comprises N₂ gas. In some aspects, the inert fluid is a liquid.

In some aspects, the inert fluid is flown through the fluidized bed reactor at a flow rate of from about 3 times to about 8 times a minimum fluidization velocity of the fluidized bed reactor comprising the solid sorbent, or from about 4 times to about 7 times, or from about 5 times to about 6 times, or from about 3 times to about 6 times, or from about 4 times to about 5 times, or from about 5 times to about 8 times, or from about 6 times to about 7 times a minimum fluidization velocity of the fluidized bed reactor with the solid sorbent.

In some aspects, the microwave irradiation heats the fluidized solid sorbent to a temperature of from about 40° C. to about 100° C., or from about 45° C. to about 95° C., or from about 50° C. to about 90° C., or from about 55° C. to about 85° C., or from about 60° C. to about 80° C., or from about 65° C. to about 75° C., or from about 40° C. to about 70° C., or from about 45° C. to about 65° C., or from about 50° C. to about 60° C., or from about 70° C. to about 100° C., or from about 75° C. to about 95° C., or from about 80° C. to about 90° C.

In some aspects, the microwave irradiation heats the fluidized solid sorbent to a temperature of from about 30° C. to about 100° C., or from about 35° C. to about 95° C., or from about 40° C. to about 90° C., or from about 45° C. to about 85° C., or from about 50° C. to about 80° C., or from about 55° C. to about 75° C., or from about 60° C. to about 70° C., or from about 30° C. to about 65° C., or from about 35° C. to about 60° C., or from about 40° C. to about 55° C., or from about 45° C. to about 50° C., or from about 65° C. to about 100° C., or from about 70° C. to about 95° C., or from about 75° C. to about 90° C., or from about 80° C. to about 85° C.

In some aspects, the microwave irradiation has a power of from about 15 W to about 30 W, or from about 16 W to about 28 W, or from about 18 W to about 26 W, or from about 20 W to about 24 W, or from about 15 W to about 22 W, or from about 16 W to about 20 W, or from about 22 W to about 30 W, or from about 24 W to about 28 W.

In some aspects, the microwave irradiation has a power of from about 4 W to about 30 W, or from about 6 W to about 28 W, or from about 8 W to about 26 W, or from about 10 W to about 24 W, or from about 12 W to about 22 W, or from about 14 W to about 20 W, or from about 16 W to about 18 W, or from about 4 W to about 18 W, or from about 6 W to about 16 W, or from about 8 W to about 14 W, or from about 10 W to about 12 W, or from about 16 W to about 30 W, or from about 18 W to about 28 W, or from about 20 W to about 26 W, or from about 22 W to about 24 W.

In some aspects, from about 50% to about 100% of the captured composition is desorbed, or from about 50% to about 90%, or from about 50% to about 80%, or from about 50% to about 70%, or from about 50% to about 60%, or from about 60% to about 100%, or from about 60% to about 90%, or from about 60% to about 80%, or from about 60% to about 70%, or from about 70% to about 100%, or from about 70% to about 90%, or from about 70% to about 80%, or from about 80% to about 100%, or from about 80% to about 90%, or from about 90% to about 100%, or from about 91% to about 100%, or from about 92% to about 100%, or from about 93% to about 100%, or from about 94% to about 100%, or from about 95% to about 100%, or from about 96% to about 100%, or from about 97% to about 100%, or from about 98% to about 100%, or from about 99% to about 100%.

In some aspects, the method has an overall energy consumption of from about 2.5 MJ to about 30 MJ per kg of desorbed captured composition, or from about 3 MJ to about 28 MJ, or from about 4 MJ to about 26 MJ, or from about 6 MJ to about 24 MJ, or from about 8 MJ to about 22 MJ, or from about 10 MJ to about 20 MJ, or from about 12 MJ to about 18 MJ, or from about 14 MJ to about 16 MJ, or from about 2.5 MJ to about 15 MJ, or from about 3 MJ to about 14 MJ, or from about 4 MJ to about 12 MJ, or from about 6 MJ to about 10 MJ, or from about 15 MJ to about 30 MJ, or from about 16 MJ to about 28 MJ, or from about 18 MJ to about 26 MJ, or from about 20 MJ to about 24 MJ per kg of desorbed captured composition.

In another aspect, provided is a method of carbon capture, the method comprising: a) providing a solid sorbent in a fluidized bed reactor; b) fluidizing the solid sorbent by flowing air comprising CO₂ through the fluidized bed reactor, wherein at least a portion of the CO₂ is adsorbed onto the solid sorbent; and c) refluidizing the solid sorbent having CO₂ adsorbed thereon by flowing an inert fluid through the fluidized bed reactor; and d) irradiating the fluidized solid sorbent having CO₂ adsorbed thereon with microwave irradiation, thereby desorbing at least a portion of the captured composition from the fluidized solid sorbent.

In some aspects the solid sorbent comprises zeolite, silica gel, activated carbon, a metal organic framework, or any combination thereof. In some aspects, the solid sorbent has a particle diameter of from about 175 μm to about 250 μm, or from about 185 μm to about 240 μm, or from about 195 μm to about 230 μm, or from about 205 μm to about 220 μm, or from about 175 μm to about 205 μm, or from about 185 μm to about 195 μm, or from about 220 μm to about 250 μm, or from about 230 μm to about 240 μm.

In some aspects, the air comprising CO₂ is flown through the fluidized bed reactor at a flow rate of from about 3 times to about 8 times a minimum fluidization velocity of the fluidized bed reactor with the solid sorbent, or from about 4 times to about 7 times, or from about 5 times to about 6 times, or from about 3 times to about 6 times, or from about 4 times to about 5 times, or from about 5 times to about 8 times, or from about 6 times to about 7 times a minimum fluidization velocity of the fluidized bed reactor with the solid sorbent.

In some aspects, the adsorbed CO₂ has a concentration of from about 0.8 mmol to about 1.5 mmol per g of solid sorbent, or from about 0.9 mmol to about 1.4 mmol, or from about 1 mmol to about 1.3 mmol, or from about 0.8 mmol to about 1.2 mmol, or from about 0.9 mmol to about 1.1 mmol, or from about 1.2 mmol to about 1.5 mmol, or from about 1.3 mmol to about 1.4 mmol.

In some aspects, the adsorbed CO₂ has a concentration of from about 0.2 mmol to about 1.5 mmol per g of solid sorbent, or from about 0.3 mmol to about 1.4 mmol, or from about 0.4 mmol to about 1.3 mmol, or from about 0.5 mmol to about 1.2 mmol, or from about 0.6 mmol to about 1.1 mmol, or from about 0.7 mmol to about 1 mmol, or from about 0.8 mmol to about 0.9 mmol, or from about 0.2 mmol to about 1 mmol, or from about 0.3 mmol to about 0.9 mmol, or from about 0.4 mmol to about 0.8 mmol, or from about 0.5 mmol to about 0.7 mmol, or from about 0.8 mmol to about 1.5 mmol, or from about 0.9 mmol to about 1.4 mmol, or from about 1 mmol to about 1.3 mmol, or from about 1.1 mmol to about 1.2 mmol.

In some aspects, the inert fluid is a gas. In some aspects, the inert fluid comprises N₂ gas. In some aspects, the inert fluid is a liquid. In some aspects, the inert fluid is flown through the fluidized bed reactor at a flow rate of from about 3 times to about 8 times a minimum fluidization velocity of the fluidized bed reactor with the solid sorbent, or from about 4 times to about 7 times, or from about 5 times to about 6 times, or from about 3 times to about 6 times, or from about 4 times to about 5 times, or from about 5 times to about 8 times, or from about 6 times to about 7 times a minimum fluidization velocity of the fluidized bed reactor with the solid sorbent.

In some aspects, the microwave irradiation heats the fluidized solid sorbent to a temperature of from about 40° C. to about 100° C., or from about 45° C. to about 95° C., or from about 50° C. to about 90° C., or from about 55° C. to about 85° C., or from about 60° C. to about 80° C., or from about 65° C. to about 75° C., or from about 40° C. to about 70° C., or from about 45° C. to about 65° C., or from about 50° C. to about 60° C., or from about 70° C. to about 100° C., or from about 75° C. to about 95° C., or from about 80° C. to about 90° C.

In some aspects, the microwave irradiation heats the fluidized solid sorbent to a temperature of from about 30° C. to about 100° C., or from about 35° C. to about 95° C., or from about 40° C. to about 90° C., or from about 45° C. to about 85° C., or from about 50° C. to about 80° C., or from about 55° C. to about 75° C., or from about 60° C. to about 70° C., or from about 30° C. to about 65° C., or from about 35° C. to about 60° C., or from about 40° C. to about 55° C., or from about 45° C. to about 50° C., or from about 65° C. to about 100° C., or from about 70° C. to about 95° C., or from about 75° C. to about 90° C., or from about 80° C. to about 85° C.

In some aspects, the microwave irradiation has a power of from about 15 W to about 30 W, or from about 16 W to about 28 W, or from about 18 W to about 26 W, or from about 20 W to about 24 W, or from about 15 W to about 22 W, or from about 16 W to about 20 W, or from about 22 W to about 30 W, or from about 24 W to about 28 W.

In some aspects, the microwave irradiation has a power of from about 4 W to about 30 W, or from about 6 W to about 28 W, or from about 8 W to about 26 W, or from about 10 W to about 24 W, or from about 12 W to about 22 W, or from about 14 W to about 20 W, or from about 16 W to about 18 W, or from about 4 W to about 18 W, or from about 6 W to about 16 W, or from about 8 W to about 14 W, or from about 10 W to about 12 W, or from about 16 W to about 30 W, or from about 18 W to about 28 W, or from about 20 W to about 26 W, or from about 22 W to about 24 W.

In some aspects, from about 50% to about 100% of the adsorbed CO₂ is desorbed, or from about 50% to about 90%, or from about 50% to about 80%, or from about 50% to about 70%, or from about 50% to about 60%, or from about 60% to about 100%, or from about 60% to about 90%, or from about 60% to about 80%, or from about 60% to about 70%, or from about 70% to about 100%, or from about 70% to about 90%, or from about 70% to about 80%, or from about 80% to about 100%, or from about 80% to about 90%, or from about 90% to about 100%, or from about 91% to about 100%, or from about 92% to about 100%, or from about 93% to about 100%, or from about 94% to about 100%, or from about 95% to about 100%, or from about 96% to about 100%, or from about 97% to about 100%, or from about 98% to about 100%, or from about 99% to about 100%.

In some aspects, the method has an overall energy consumption of from about 2.5 MJ to about 30 MJ per kg of desorbed CO₂, or from about 3 MJ to about 28 MJ, or from about 4 MJ to about 26 MJ, or from about 6 MJ to about 24 MJ, or from about 8 MJ to about 22 MJ, or from about 10 MJ to about 20 MJ, or from about 12 MJ to about 18 MJ, or from about 14 MJ to about 16 MJ, or from about 2.5 MJ to about 15 MJ, or from about 3 MJ to about 14 MJ, or from about 4 MJ to about 12 MJ, or from about 6 MJ to about 10 MJ, or from about 15 MJ to about 30 MJ, or from about 16 MJ to about 28 MJ, or from about 18 MJ to about 26 MJ, or from about 20 MJ to about 24 MJ per kg of desorbed CO₂.

### EXAMPLES

### Example 1: Experimental Microwave Assisted CO₂ Desorption of a Solid Sorbent in a Fluidized Bed Reactor

Carbon dioxide (CO₂) has been claimed to be the largest greenhouse gas emission contributor to the climate change and global warming with the CO₂ emissions of 36 GT/yr (Kolle, J .M., et al., 2021) (Houghton, J., 2015). As the CO₂ level in the atmospheric air increased 40% in the last two centuries, a report in The Intergovernmental Panel on Climate Change stated that the CO₂ emissions needs to be reduced by 41-72% in order to maintain the temperature increase of the earth under 2° C. by 2050 (IEA, 2016) (Change, I. C., 2014) (Yassin, M. M., et al., Journal of Environmental Chemical Engineering, 2021). Carbon Capture, Storage and Utilization (CCUS) methods have been one of the most effective ways to combat with greenhouse gas emissions (McGurk, S. J., et al., 2017). Within different CO₂ capture technologies, although the most advanced and commercially available technology is the liquid amine scrubbing process; it has several disadvantages such as significant energy consumption, high corrosion, high solvent losses and degradation (Yassin, M .M., et al., Journal of Environmental Chemical Engineering, 2021) (Meloni, E., et al., 2021). An alternative to liquid absorbents, adsorption-based approach using solid sorbents can eliminate the drawbacks of amine based aqueous solvents due to its simplicity, high efficiency, and low energy requirement (Meloni, E., et al., 2021) (Ellison, C., et al., 2021). Several different adsorbents such as zeolite, silica gel, activated carbon, and metal organic frameworks have been tested for CO₂ capture, and found that all those materials showed high CO₂ adsorption capacity (Hauchhum, L. and P. Mahanta, 2014) (Pal, A., et al., 2016) (Wang, H., et al., 2014) (Meloni, E., et al., 2021). Besides adsorption capacity, the characterization of the materials in terms of good mechanical properties, low energy requirements for desorption process, high stability, CO₂ recovery and purity as well as large CO₂/N₂ separation factor are also important (Meloni, E., et al., 2021). There are several different desorption methods in adsorption-based carbon capture technologies. Pressure and/or vacuum swing adsorption (P/VSA), temperature swing adsorption, or the combination of both modes of temperature vacuum swing adsorption (TVSA) are the most common methods (Ellison, C., et al., 2021). In a conventional temperature swing adsorption (TSA) process, the sorbent is heated by either passing a heated inert gas or heating the regenerator column by repetitive heating elements. The energetic efficiency of both methods are quite low due to the heat losses and considerable energy requirement to heat inert gasses (Ellison, C., et al., 2021). To eliminate heat losses and speed up the desorption processes, microwave heating has been proved as a promising method for CO₂ regeneration using less energy compared to conventional thermal heating since it can heat the sorbent directly without heating the reactor walls (Mohd Pauzi, M. M. I., et al., 2022) (An, K., et al., 2023). As opposite to the conventional heating, microwave can heat the sorbent via direct molecular interactions with the electromagnetic radiations (dielectric and volumetric heating) which can eliminate the heat transfer limitations (Bougie, F. and X. Fan, 2018). Furthermore, the heating rate of the microwaves are significantly higher than that of traditional heating which could increase the energy efficiency, productivity, and cost-effectiveness of TSA processes (Jang, G. G., et al., 2023). Although there are several studies investigated the microwave heating on the desorption of CO₂ for post-combustion using both liquid and solid sorbent, there is a need for further work to understand the energy consumption of regeneration processes. Microwave technology usage for desorption applications has begun in 1981 by Roussy and Chenot (Roussy, G. and P. Chenot, 1981) to desorb water from Zeolite 13X. In the recent years, a good number of studies have investigated the microwave swing adsorption processes for CO₂ desorption. McGurk et al. (McGurk, S. J., et al., 2017) performed an experimental work to compare the desorption characteristics of aqueous monoethanolamine using conventional and microwave heating. The authors found that while regeneration was achieved at the temperature range of 120-140° C. with conventional heating, it was achieved at lower temperatures (70-90° C.) under microwave irradiation which resulted in reduction in the energy consumption and cost. Another study conducted by Bougie et al. (Bougie, F. and X. Fan, 2018) investigated the effect of microwave heating varying several parameters such as amine concentration, regeneration temperature and initial microwave power to evaluate regeneration efficiency, recovered CO₂ amount and energy consumption. The authors claim that a regeneration temperature of 90° C. was found to provide the best performance in terms of energy consumption. While the initial microwave power is also found to be 100 W to achieve the target regeneration temperature, increasing initial microwave power slightly reduces the energy consumption. Li et al. (Li, Y., et al., 2020) performed experimental work to compare the energy consumption, and regeneration efficiency of a CO₂ desorption process of two non-aqueous solutions using both microwave and conductive heating. Under the conditions of 800 W, while the energy consumption decreased by 76%, the CO₂ recovery increased 2.7 times when microwave is used for regeneration process.

As stated earlier, a variety of solid sorbent materials (zeolite 13X, MOF, activated carbon, silica gel) have been investigated under microwave irradiation for CO₂ desorption. Some of the pioneer studies in this field was performed by Chronopoulos et al. (Chronopoulos, T., 2016) (Chronopoulos, T., et al., Microporous and Mesoporous Materials, 2014) (Chronopoulos, T., ct al., Energy Procedia, 2014). The authors used activated carbon as a sorbent material in a packed bed, and varied flue gas composition, gas flow rate, regeneration temperature and moisture presence. It was claimed that while the performance efficiency of the sorbent enhanced 10%, the Microwave Swing Adsorption (MSA) technology reduced the regeneration time and energy consumption by 30% and 40%, respectively, compared to the TSA process. Furthermore, the authors found that the microwave regeneration process is four times faster than that of conventional heating. Ellison et al. (Ellison, C., et al., 2021) investigated the effects of regeneration temperature and microwave power on the desorption characteristics for a post combustion process under microwave and conventional heating conditions. The authors found that the regeneration time is at least twice faster using microwave technology compared to traditional heating. It was also claimed that microwave regeneration increased the adsorption/desorption cycling productivity and reduced the energy penalty of temperature swing capture from 41.5 KJ/mol to 16-19 KJ/mol. Meloni et al. (Meloni, E., et al., 2021) performed experimental work to find optimal operation conditions for CO₂ desorption of Zeolite 13X at 300° C. under microwave irradiation. The authors obtained a 75% energy efficiency with a perfect repeatability of the results which proved that no modification took place in zeolites after microwave irradiation. Webley and Zhang (Webley, P. A. and J. Zhang, 2014) performed a proof-of-concept experiments to investigate the effect of microwave to desorb CO₂ from Zeolite 13X under wet and dry conditions. The authors found that the addition of microwave not only improved the CO₂ purity up to 80% but also improved the time of the CO₂ and water desorption. Another recent study conducted by Yassin et al. (Yassin, M. M., et al., Journal of Environmental Chemical Engineering, 2021) also investigated the effect of humidity on the adsorption and desorption processes of flue gas using Zeolite 13X and Norit R2030CO2 (activated carbon) under microwave conditions. The authors evaluated the effect of parameters on the time of full regeneration, CO₂ capture capacity, recovery, purity, and desorption kinetics. It was found that the microwave assisted regeneration process provided higher CO₂ purity, recovery and productivity compared to traditional heating. The time need to achieve 50, 80, 90, and 99% regeneration also investigated here. They claim that to remove the last 9% of the adsorbate remaining in the sorbent while half of the desorption time was spent in TSA, it was a third of total regeneration time in the microwave-assisted process. It was also suggested here that regenerating 90% of these adsorbents instead of 99% can decrease the energy consumption and desorption time dramatically. Rueda et al. (Gomez-Rueda, Y., et al., 2022) performed experiments using a multimode microwave for CO₂ desorption process using activated carbon for post-combustion applications. While the desorption was achieved extremely fast within 79 seconds, the authors stated that the adsorption bed was not heated uniformly due to hot spots in the multimode MW cavities.

Microwave assisted desorption processes also being used for Direct Air Capture (DAC) systems to remove CO₂ from atmospheric air. Schagen et al. (van Schagen, T .N., et al., 2022) compared traditional and microwave swing desorption process for DAC systems using Lewatit VP OC 1065 in a fixed and moving bed. While the productivity was found to be 1.5 CO₂/kg_{sorb}/d, the total energy duty varied between 25 and 50 MJ/kg CO₂. Although microwave system improved the productivity, the authors claim that more homogenous electric field could be created as several hot spots were observed due to non-homogenous electric field in the setup. Ji et al. (Ji, T., et al., 2023) also investigated the kinetics and activated energy of desorption system under microwave conditions for a DAC unit, and the activation energy can be reduced to 20-28 KJ/mol with microwave irradiation. An interesting claim has been done here that the temperature difference between adsorption and desorption process can be as low as less than 10° C. which means that the desorption can take place when the temperature of the sample is close to 40° C. Li et al. (Li, S., et al., 2021) (Li, S. and F. Gallucci, 2022) performed two experimental works to investigate the effect of plasma in the desorption of CO₂ using hydrotalcite. The experiments have been conducted under two different CO₂ concentrations: 50% and 400 ppm (to simulate direct air capture conditions). The effect of discharge power and gas flow rate on the desorption process was examined and power was claimed to have more effect. However, the energy efficiency of the proposed system was found be lower than 1%. Therefore, the authors suggested using microwave to increase the energy efficiency higher than 50%. A recent comprehensive review published by An et al. (An, K., et al., 2023) on the regeneration strategies for direct air capture also claim that regeneration energy demand can be reduced by microwave heating technology.

In this example, an experimental setup has been built using a mono-mode microwave unit. As discussed earlier, although multimode microwaves are capable to achieve a complete desorption process, there is a substantial possibility of having hot spots in multimode microwave units (Gomez-Rueda, Y., et al., 2022) (van Schagen, T. N., et al., 2022). The effect of flow rate, regeneration temperature and microwave initial power have been varied to investigate their effects on the desorption characteristics and energy consumption.

Most of the studies on CO₂ desorption applying both TSA and MSA processes used packed bed reactor. In this example, a fluidized bed reactor has been used instead of packed bed or moving bed which not only create more homogenous temperature distribution but also enhance the heat transfer within the sorbent as well as more efficient gas-solid contact (Cherbański, R. and E. Molga, 2009). Cherbanski and Molga (Cherbański, R. and E. Molga, 2009) reviewed the potential of microwave systems on the desorption processes. Several reactors and bed types have been discussed and claim that fluidized bed adsorbers may perform better than fixed-bed reactors to generate more homogenous temperature distribution. Cui et al. (Cui, Y., et al., 2020) provided the advantages of fluidized bed technology such as; improving heating uniformity, minimizing thermal runaway, maturity of the technology which has been used in power generation and drying processes. The authors also claim that microwave-assisted fluidized bed prevents hot spots (localized heating) in the medium.

Although several studies have discussed about the energy consumption of the microwave swing desorption process very briefly, there is not a detailed study that focused on the total microwave energy absorbed by the sorbent under different conditions.

A detailed investigation of desorption time and energy consumption have been done by dividing the desorption percentages (50%, 75%, 90%, 99%, 100%).

While magnetrons were used for the microwave assisted desorption processes in the literature (Yassin, M. M., et al., Journal of Environmental Chemical Engineering, 2021) (McGurk, S. J., et al., 2017) (Ellison, C., et al., 2021) (Meloni, E., et al., 2021) (Bougie, F. and X. Fan, 2018) (Chronopoulos, T., 2016), (Chronopoulos, T., et al., Microporous and Mesoporous Materials, 2014) (Chronopoulos, T., et al., Energy Procedia, 2014) (Webley, P. A. and J. Zhang, 2014) (van Schagen, T. N., et al., 2022) (Yassin, M. M., et al., Separation and Purification Technology, 2021) (Bougie, F., et al., 2019), a solid-state microwave generator has been used in this study which provides accurate power delivery, frequency tuning, and reflected power measurement.

### Methods

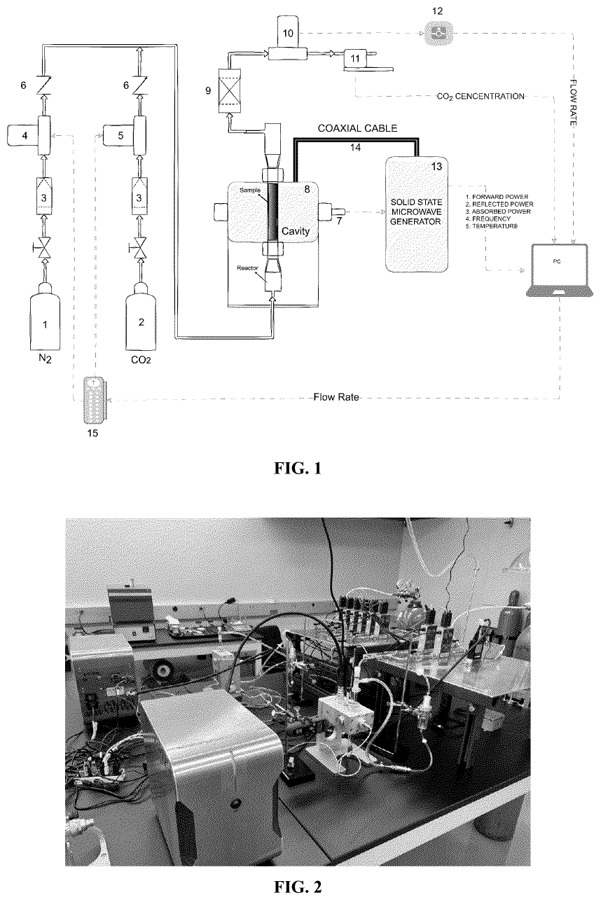

Experimental Setup: FIG. 1 and FIG. 2 illustrate the experimental setup built in this study for CO₂ adsorption and desorption processes. Zeolite 13X (Na₈₆[AlO₂)₈₆(SiO₂)₁₀₆]·xH₂O) with a mesh size of 60-80 (177-250 μm) from Sigma Aldrich (20305) was used as a sorbent to achieve a proper fluidization. The samples (3 gr) for each experiment were kept in a Quincy Lab convection oven at 175° C. to remove any volatiles from the sorbent. The reactor was manufactured at the glassblowing facility of the University of Alabama and was made of borosilicate glass with an inner and outer diameter of 16 and 18 mm, respectively. A mono-mode microwave unit (Sairem, MicroChem) (Inc., S., MicroChem User Manual. 2023), which includes a solid-state microwave generator and a cavity, was used as a heat source for the regeneration processes. Although magnetrons are the most common devices to generate microwaves, they have significant limitations, for example, power control difficulties, high voltage supply usage, and limited lifetime (Dąbrowska, S., et al., 2018) (Díaz de Greñu, B., et al., 2023). On the other hand, solid-state microwave generators, which are based on semiconductor technology, have gained attention as an alternative to magnetrons. The solid-state technology allows for accurate power delivery, frequency tuning, and reflected power measurement (Inc., S., MicroChem User Manual. 2023). The stable power in this technology provides more homogeneous microwave irradiation to the mass in the cavity to be heated, which diminishes the risk of overheating and hotspots (Díaz de Greñu, B., et al., 2023).

As shown in FIG. 1, the MicroChem generator was connected to the cavity by a MW coaxial cable. While microwave power changed between 0 and 200 W, the operational frequency varied between 2400 and 2500 MHz with a frequency synthesizer. The stub was adjusted manually before starting experiments to ensure the adsorbent material absorbs the maximum MW power forwarded by the MW generator. The temperature of the sample was measured by a pyrometer (Optris CT LT 22), which was connected to the MW generator. The adjustment of power for different modes in the MicroChem unit was made by reading the temperature from the pyrometer. Full control of the microwave process proceeded via PC, using the GeneLink software. Two mass flow controllers (MKS GE50A series) with a flow range of 0-1000 mL/min for N₂ and 0-100 mL/min for CO₂ were used to feed the reactor. The outlet gas stream from the reactor passed through an extreme moisture trap and filter (CM-0103) to remove moisture. Then, the leaving gas was analyzed in a non-dispersive infrared (NDIR) CO₂ sensor (ExplorIR™-M 100%, CM-40831) which measured the concentration of CO₂. The mass flow rate of the gases before the CO₂ sensor was measured by a mass flow meter (Omega FMA-1620A-I2, 0-1 SLM). A smart probe (Omega, SP-014-1) was connected to the mass flow meter to provide signals to the data acquisition unit. While the data for forward, reflected, and absorbed power as well as temperature and frequency were collected using the GeneLink Software provided by Sairem Corp., the data for mass flow rate and CO₂ concentration of the leaving gas were collected using Sync and GasLab software, respectively. All data from each unit was saved with one-second intervals. A microwave leakage detector (Reed Instruments) was used to control any possible microwave leakage while MW unit was operational.

Reactor and Cavity Configuration: On the cavity of MicroChem unit, a mechanical system allowed the orientation of the applicator to be changed to irradiate the product either parallel (E orientation) or perpendicular (H orientation) to the electric field. This system provided a good cavity matching for a wide range of product dielectric permittivity. The cavity accommodated different product volumes from 1 to 25 mL with the outer diameters of reactors of 10, 18, and 24 mm.

Ellison et al. (Ellison, C., et al., 2021) measured the dielectric properties of fresh and dried Zeolite 13X which was the same material used in this study. While dielectric constant (ε′) was obtained to be 3.5, the dielectric loss tangent (ε″/ε′) was 0.165 at 2.45 GHz frequency. The authors claimed that these values reflected a good ability to couple to MW field and absorb MW energy. Sairem Corp. has provided recommendations on the optimal cavity orientation based on dielectric properties of the sample. According to the dielectric properties of Zeolite 13X, an 18 mm reactor which was produced by the Glassblowing Facility at the University of Alabama was used in parallel mode (E18).

Experimental Procedures: In this study, two main processes (adsorption and desorption) were investigated, with a focus on the desorption stage under microwave conditions. Before starting experiments, the microwave stub was adjusted for the sample to absorb as much as possible microwave power by operating the solid-state MW generator in the manual mode with a power of 30 W. Three grams of Zeolite 13X were filled into the reactor, then the desired temperature was set to 100° C., and the stub adjustment was completed in two-three cycles.

The Zeolite 13X was kept in a conventional oven overnight at 175° C. to remove any volatiles as performed by Ellison et al (Ellison, C. et al., 2021). Once the reactor was filled with the solid sorbent, the reactor was fed with N₂ with a flow rate of 200 mL/min for about 20 minutes to provide a CO₂ free environment. During the adsorption stage, a gas mixture of CO₂ (5%) and N₂ (95%) fed the reactor with flow rates of 200, 500, 750, and 1,000 mL/min. The CO₂ concentration of 5% in this study simulated the exhaust gas of a gas fired power plant (Chronopoulos, T., 2016). The fluidized bed minimum velocity calculations, the minimum fluidization velocity and volumetric flow rate for the given particle size (average of 213.5 μm), particle density (640 kg/m³), and reactor diameter (16 mm) were obtained as 0.01605 m/s and 193.6 mL/min, respectively. Hence, while 200 mL/min simulated the packed bed conditions, the other three volumetric flow rates were selected for fluidized bed experiments. The adsorption was completed once the sorbent material was saturated with CO₂ at 5% within 30 minutes for each experiment. After the completion of adsorption, the feeding gas was changed to 100% N₂, with the same total flow rate as the adsorption stage for each respective experiment, as a purge gas to transfer all CO₂ which was released during the regeneration process. Simultaneously, microwave radiation was turned on for the selected maximum power and regeneration temperature. It should be noted here that the microwave power here represents the maximum set power to achieve and keep the desired regeneration temperature. Hence, once the sample temperature reached close to the regeneration temperature, the solid-state MW generator decreased the forward power to keep the regeneration temperature as close as possible to the target temperature. The microwave unit was stopped when the CO2 concentration of the leaving gas from the reactor reached to 0.1%.

### Calculation Methods and Parametric Studies:

Minimum Fluidization Velocity Calculation: Fluidization plays an important role in heat transfer rate, which can increase the rate five to ten times higher than packed-bed reactors. Following a study from Cocco et al. (Cocco, R. et al., 2014), the minimum fluidization velocity calculations, using the assumptions from TABLE 1, was made as follows:

$$A r = \frac{{ρ}_{g} {d}_{p}^{3} ( {ρ}_{p} - {ρ}_{g} ) g}{{μ}^{2}}$$

where Ar is the Archimedes number, dₚ is the Sauter mean particle size, g is the acceleration of gravity, μ is the viscosity of the gas, ρ_{g} and ρₚ are the densities of gas and particle, respectively. A second-order polynomial correlation between the Archimedes number and Reynolds number proposed by Wen and Yu (Wen, C. Y. et al., 1966) was used to find the Reynolds number at the minimum fluidization velocity.

$$Ar = 1.65 {Re}_{p , m f} + 24 {Re}_{p , mf}^{2}$$

Once the Reynolds number is known, the minimum fluidization velocity can be easily calculated as follows:

$${Re}_{p , m f} = \frac{{ρ}_{g} {u}_{m f} {d}_{p}}{μ}$$

TABLE 1
Properties of Zeolite 13X for minimum
fluidization velocity calculations.

| Properties | Symbol | Unit | Value |
|---|---|---|---|
| Particle diameter | dp | (μm) | 177-250 |
| Particle density | ρp | kg/m³ | 640 |
| Sphericity | Φ | — | 0.6 |
| Bed height | Hb | mm | 28 |
| Bed diameter | db | mm | 16 |
| Gas mixture density | ρ_{g} | kg/m³ | 1.178 |
| Gas mixture viscosity | μ | kg/s-m | 1.76e−05 |

According to the assumptions and calculations, the minimum fluidization velocities and their corresponding volumetric flow rates were obtained in the ranges from 0.01104 to 0.02196 m/s and 133.2 to 264.9 mL/min, respectively, for the particle diameter ranges between 177-250 μm. It should be noted that the bubbling regime in the fluidization observed when the flow rate was higher than 300 ml/min.

When the reactor was filled with 3 gr. of Zeolite 13X, the initial bed height was measured as 28 mm. Four different flow rates (200, 500, 750, and 1,000 mL/min) were used in this study. The bed expansion ratio is calculated as follows (Cui, Y., et al., Experimental fluidization performances of silicon carbide in a fluidized bed. Chemical Engineering and Processing—Process Intensification, 2020. 154: p. 108016):

$$∞ = \frac{H}{{H}_{0}}$$

where H and H₀ are the bed height when the fluidization velocity is higher than 0 m/s and 0 m/s, respectively. The expansion ratios for different flow rates are listed in TABLE 2, and the bed height increased up to 61% when the flow rate increased to 1,000 mL/min.

TABLE 2
Fluidization characteristics at different flow rates.

| Flow Rate | Velocity | | | | V₀ | V | Residence |
|---|---|---|---|---|---|---|---|
| (Nml/min) | (m/s) | H₀ (mm) | H (mm) | α | (mL) | (mL) | Time (s) |
| 500 | 0.041 | 28 | 36 | 1.29 | 5.630 | 7.238 | 0.869 |
| 750 | 0.062 | 28 | 40 | 1.43 | 5.630 | 8.042 | 0.579 |
| 1,000 | 0.083 | 28 | 45 | 1.61 | 5.630 | 9.048 | 0.434 |

Adsorption-Desorption Capacities and Energy Consumption: As can be seen from TABLE 3, several experiments were performed to investigate the effects of flow rate, microwave power, and regeneration temperature on the desorption capacity and time, microwave power efficiency as well as energy consumption for complete desorption processes. While the flow rate of the feeding gas changed from 200 mL/min to 1,000 mL/min, regeneration temperature varied from 40° C. to 100° C. Microwave forward power range varied between 15 W and 30 W with an increment of 5 W. The MW power range was kept as low as possible to have full control of the temperature of the adsorbent material. The microwave power listed in TABLE 3 represents the maximum forward power which was exposed to the sample. The forward power was adjusted once the target temperature was reached in all cases.

TABLE 3
Experimental conditions.

| Exp. No | Flow Rate | Power | Temperature |
|---|---|---|---|
| 1-3 | 500N ml/min | 15 W | 40-70-100° C. |
| 4-6 | | 20 W | 40-70-100° C. |
| 7-9 | | 25 W | 40-70-100° C. |
| 10-12 | | 30 W | 40-70-100° C. |
| 13-15 | 750N ml/min | 15 W | 40-70-100° C. |
| 16-18 | | 30 W | 40-70-100° C. |
| 19-21 | 1000N ml/min | 15 W | 40-70-100° C. |
| 22-24 | | 30 W | 40-70-100° C. |
| 23-26 | 200N ml/min | 15 W | 40-70-100° C. |
| 27-30 | | 30 W | 40-70-100° C. |

To investigate desorption characteristics in terms of power and energy consumptions, adsorption and desorption capacities were calculated. Adsorption capacity was obtained by integrating the difference of CO₂ flow rate between inlet and outlet of the reactor. A gas mixture of 5% CO₂ and 95% N₂ was used as a feed gas with different flow rates. The following equation was used for the adsorption capacity:

$${q}_{a d s} = \frac{{ρ}_{{CO}_{2}}}{m} {\int }_{0}^{{t}_{a d s}} ( {Q}_{i n} {C}_{i n , {CO}_{2}} - {Q}_{out} {C}_{out , {CO}_{2}} ) d t$$

where Qᵢₙ and Qₒᵤₜ are the volumetric flow rates of inlet and outlet of the reactor, respectively (Ellison, C., et al., 2021) (Chronopoulos, T., 2016). While m is the total mass of Zeolite 13X, which remained constant at 3 gr in all experiments, ρ_{co}_{₂} represents the density of CO₂ at 20° C. and 1 bar (1.842 kg/m³). It should be noted here that blank tests were also performed to subtract the dead volume from the adsorption and desorption breakthrough curves. Therefore, four different blank tests were conducted with an empty reactor using a gas mixture of 5% CO₂ and 95% N₂, and corrected adsorption and desorption capacities were calculated by experimental results from the actual sorbent experiments.

Using a similar integration method, desorbed CO₂ amounts (q_{des}) in terms of mmol CO₂/g Zeolite were calculated by the following equation:

$${q}_{des} = \frac{{Q}_{out} \times {ρ}_{{CO}_{2}}}{m} {\int }_{0}^{{t}_{a d s}} ( {C}_{{CO}_{2}}^{out} ) d t$$

Here, while C_{CO}_{₂}^{out} represents the CO₂ concentration, Qₒᵤₜ is the volumetric flow rate of the released gas from the reactor, using Nitrogen as an internal reference standard (Ellison, C., et al., 2021) (Chronopoulos, T., 2016) (van Schagen, T. N. et al., 2022).

Since the focus of this study is to investigate the regeneration process under microwave conditions, energy consumption to capture a unit of CO₂ is vitally important. The energy consumption (EC) to regenerate a kg of CO₂ was calculated using the following equation:

$$E C = \frac{{E}_{a b s} ( MJ )}{{q}_{{CO}_{2}} ( kg )} = \frac{{\int }_{0}^{{t}_{d e s}} {P}_{a b s} ( t ) d t}{m \times {q}_{d e s}}$$

Here q_{co}_{₂}, P_{abs} and E_{abs} are the amount of desorbed CO₂, the microwave power and absorbed energy by the sorbent material, respectively (Bougie, F. et al., 2018).

MicroChem MW unit has several power set point modes, such as manual and temperature set point. While manual mode provides a fixed set power to the sample until the desired temperature is reached, temperature set point mode adjusts the required power based on the target temperature of the sample by setting a maximum forward power. The balance of microwave power is given by the following equations:

$${P}_{transmitted} = {P}_{f o r w a r d s} - {P}_{r eflected}$$

The forward power here is defined as the microwave power generated by the solid-state MW generator. The definition of the reflected power is the portion of the generated microwave power that was not absorbed during the process and that returns to the solid-state microwave generator. The generator dissipates this power using an isolator. The value of the reflected power is an important parameter, indicating the efficiency of the interaction between microwaves and the material. Lower reflected power means stronger interaction and efficient transfer of the microwave energy to the material (Inc., S., MicroChem User Manual. 2023). The transmitted power is the amount of power dissipated outside of the generator. It is obtained by subtracting the reflected power from the forward power.

Once forward, reflected, and transmitted powers were known, absorbed power was calculated by using the following equation:

$${P}_{a b s o r b e d} = {P}_{transmitted} - {P}_{l o s s}$$

where the power loss is defined as the fraction of transmitted power that is dissipated in parts of the system other than the sample (cable, connectors, tuning stub, body of the cavity). The Sairem Corp. (Inc., S., MicroChem User Manual. 2023) claims that the absorbed power estimation, available on the interface, is an estimation of the power absorbed by the sample, based on transmitted power, and known losses (cable, connectors). The accuracy is decreased when reflected power is high (due to reflected power estimation accuracy), and/or the tuning stub is inserted deeply (due to additional losses in the stub and the cavity).

### Results

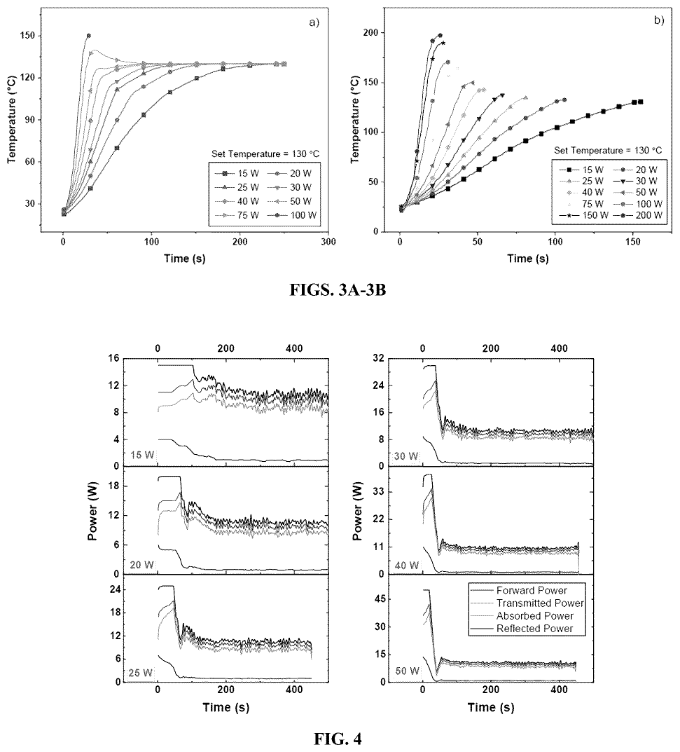

Initial Power Tests: Before running adsorption and desorption experiments, several power tests were conducted to investigate the temperature of sample and power profiles in the MicroChem unit using two different modes; namely, manual and temperature (T) set point. In these experiments, a 3 gr of Zeolite 13X was used. In both modes, while the target temperature was set to 130° C., the maximum forward power was changed between 15 W and 100 W. The only difference between these two modes is that whereas the manual mode provides a constant forward power to the sample and turns off the MW when the target temperature is reached, temperature set point starts the MW with the maximum set MW power, and then adjusts the power when the temperature of the sample reaches the target temperature. FIGS. 3A-3B show the temperature profile of the sample with time for both manual and T set point modes, as well as the required time to reach the target temperature. It should also be noted that the power values listed in TABLE 3 represent the maximum set points for the forward power. While forward power was set in this unit, the reflected power, transmitted power, and absorbed power were measured by the MW unit.

FIGS. 3A-3B show the temperature of the sample with time for two different power modes. The first observation from the graphs is that the temperature of the sample reached the target temperature in a short period for all initial MW forward power options. The only problem with using manual mode is that although the MW unit was set to turn off MW when the sample temperature was at 130° C., the sample temperature increased up to 200° C. when the forward power was set to 200 W (see FIG. 3B). The same issue was also observed when the forward power was set to 50 W, and the temperature reached close to 150° C. On the other hand, the temperature profile of the sample was quite constant when T set point mode was selected as shown in FIG. 3A, except at high powers such as 100 W.

The time to reach the target temperature with energy consumption is illustrated in TABLE 3. It was found here that the manual mode was almost twice as fast as T set point; however, there was no temperature control in this mode. On the other hand, the energy consumption was found to be higher when the T set point mode was selected, especially for low initial MW power ranges. The reason for this phenomenon relies on temperature fluctuations to keep the target temperature constant in T set point mode. To control the temperature of the sorbent during the regeneration process, all experiments were performed with the T set point mode.

TABLE 4
Time to reach 130° C. for different power modes.

| | T Set Point Mode | Manual Mode | T Set Point Mode | Manual Mode |
|---|---|---|---|---|
| Power (W) | Time (s) | Time (s) | Energy (J) | Energy (J) |
| 15 | 261 | 151 | 2496 | 1582 |
| 20 | 181 | 100 | 2035 | 1393 |
| 25 | 171 | 74 | 2044 | 1308 |
| 30 | 144 | 60 | 1845 | 1288 |
| 40 | 121 | 45 | 1786 | 1339 |
| 50 | 110 | 37 | 1684 | 1410 |
| 75 | 28 | 27 | 1124 | 1620 |
| 100 | 22 | 21 | 1295 | 1718 |
| 150 | — | 16 | — | 2145 |
| 200 | — | 14 | — | 2195 |

FIG. 4 illustrates forward, transmitted, absorbed, and reflected powers using the T set point mode, and the data was smoothed using adjacent averaging method. As shown in the graphs, most of the microwave was absorbed by the sample for all MW power options. While the forward power was constant for a longer period of time when the power rate was lower, a sharp decrease was observed in seconds when the forward power was set to 50 W since the sample reached the target temperature relatively fast. It is shown from the temperature and power profiles with time for different powers that the MicroChem MW unit provided a quite efficient system, as most portions of the forward MW power were absorbed by the sample, and the temperature control for low power range was found to be excellent.

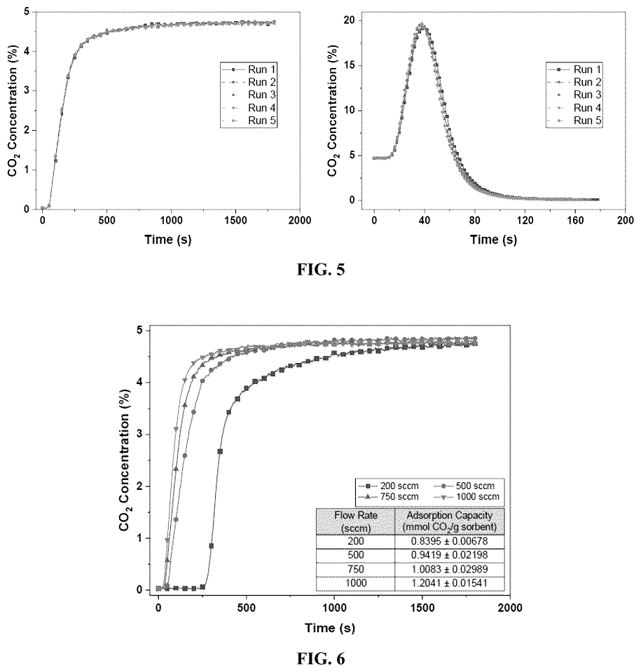

Initial Cyclic Experiments: In order to check the reusability of Zeolite 13X in the fluidized bed experiments, five cyclic experiments (under the conditions of 100° C. regeneration temperature, 500 mL/min flow rate and 30 W power) were performed. As shown in FIG. 5, CO₂ concentration profile with time for adsorption and desorption processes in all experiments were found to be almost identical. Therefore, only one sample was used to perform all experiments. It should be noted that some of the experiments were conducted with the regeneration temperatures of 40° C. and 70° C. After completing the desorption stage for these temperature conditions, the MW unit again was run the temperature set to 100° C. to make sure all CO₂ was removed from the sample. The main reason here is that since the same sample was used for all experiments, there should not be any remaining CO₂ in the sample before the next adsorption step.

Adsorption: Adsorption, the first stage of the experiments, was performed with a 3 gr Zeolite 13X filled in a borosilicate glass reactor which was fed by a gas mixture of CO₂ (5%) and N₂ (95%). As listed in TABLE 3, four different flow rate conditions were selected. While there was no bubbling observation when the flow rate was 200 mL/min, the fluidization was quite notable when the flow rates were 500, 750, and 1000 mL/min. It should also be noted that the feeding gas was distributed to the reactor using a fritted tube, which has a B type porosity (70-100 μ). The porosity of the frit is quite important in fluidization, as an A-type porosity (145-174 μ) frit did not create a uniform fluidization in the initial tests.

As shown in TABLE 3, thirty experiments were conducted, and most of the experiments were performed with the flow rate of 500 mL/min. FIG. 6 illustrates the CO₂ concentrations with time for different flow rate conditions. As can be seen from the figures and as expected, the sorbent reached saturation faster when the flow rate was higher. The amount of adsorbed CO₂ (adsorption capacity) in terms of mmol CO₂/g Zeolite is reported in FIG. 6. According to the Toth isotherm provided by Ellison et al. (Ellison, C., et al., 2021), the expected adsorption capacity of Zeolite 13X is around 1 mmol/g when the partial pressure is 0.05 bar. The average adsorption capacities in this study changed between 0.84 and 1.20 mmol/g as shown in FIG. 6. It is also shown that the amount of adsorbed CO₂ increased with increasing flow rate. The same increment trend with flow rate increment was also observed in several studies. Chronopoulos (Chronopoulos, T., 2016) provided a detailed explanation of mass transfer correlation using the method by employing Colburn-Chilton J-factor and Reynolds number. It should also be noted that the change in the breakthrough curve due to an increase in higher flow rates resulted in an increase in the adsorption capacity.

Desorption: In microwave heating, electromagnetic energy is directly converted into thermal energy compared to conventional heating in which conduction, convection, and radiation heat transfer phenomena take place (Meloni, E., et al., 2021). The mechanism behind the microwave heating relies on dipolar rotation and ionic conduction, and both mechanisms create friction between moving species and molecules which results in heat generation (Mohd Pauzi, M. M. I., et al., 2022) (Palma, V., et al., 2020). Whittington and Milestone (Whittington, B. I. et al., 1992) and Ellison et al. (Ellison, C., et al., 2021) discussed the theory of microwave heating of Zeolite 13X in detail. It was claimed that Zeolite 13X has large number of Na⁺ cations in its structure which makes Zeolite 13X a good microwave radiation absorber, hence rapid electric heating. On the other hand, although 13X includes aluminosilicate, which is almost transparent to microwave radiation, silanol groups on the surface of 13X have higher dielectric properties which increase the interaction between microwaves and Zeolites (Yassin, M. M., et al., Separation and Purification Technology, 2021) (Turner, M.D., et al., 2000). Those silanol groups coupled with electromagnetic radiation during the microwave exposure create heat flow from surface through the bulk of the material (Yassin, M.M., et al., Separation and Purification Technology, 2021). Due to volumetric heating with the microwave radiation, the whole adsorbent material receives the irradiation simultaneously, and the adsorbed CO₂ in the pores is released when the adsorption energy is exceeded (Yassin, M. M., et al., Journal of Environmental Chemical Engineering, 2021).

In this section, desorption behavior of Zeolite 13X under microwave conditions were analyzed by assessing: i) CO₂ concentration with time during desorption stage, ii) the time to achieve a complete desorption, iii) total forward power, iv) total absorbed power, v) energy consumption to desorb a kg of CO₂, vi) energy consumption in different regeneration percentages. As listed in TABLE 3, the effects of flow rate, regeneration temperature and maximum reflected power were investigated. While the flow rate changed from 200 mL/min to 1,000 mL/min, regeneration temperature varied between 40° C. and 100° C. As the absorbed power compared to reflected power can be quite high in the monomode microwaves, the maximum forward powers changed between 15 W and 30 W.

Microwave Power Effect: Microwave power in desorption is quite important, as it has a significant influence on the heating rate of the sorbent material. Higher microwave power provides higher electromagnetic field energy, which results in more intermolecular motions and friction; hence higher heat generation (Huang, Y.-F., et al., 2015). MicroChem MW unit has the capability of changing the power from 1 W to 200 W with an increment of 1 W. Desorption was completed when the CO₂ sensor read 0.1% CO₂, and all analyses were done accordingly (although some studies exposed the microwave radiation to the sample for a constant time) (McGurk, S. J., et al., 2017). However, the sample may not desorb all CO₂ that has been captured during the adsorption stage.

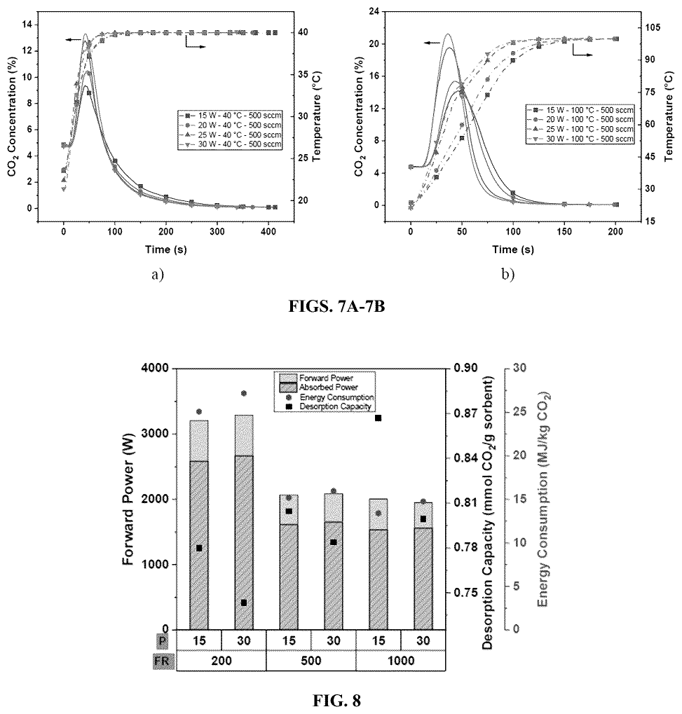

FIGS. 7A-7B show the CO₂ concentration with time when the flow rate was fixed at 500 mL/min and the power was varied from 15 W to 30 W at regeneration temperatures of 40° C. and 100° C., respectively. It is shown in the graphs that the CO₂ concentrations were higher when the forward powers were higher since more power was applied with higher heating rates to the sorbent in the beginning of the regeneration process, which resulted in a faster desorption process. While the CO₂ concentration was 13% when the forward power was 30 W, it was obtained as 9% when the forward power was decreased to 15 W. Similarly, the time to reach the regeneration temperature was also found to be lower with higher forward power. Comparing these two figures, the CO₂ concentration difference between power options was more notable when the regeneration temperature was higher. Whereas the CO₂ concentration increased from 9% to 13% when the forward power increased from 15 W to 30 W at 40° C., CO₂ concentration increased from 13% to 22% with forward power when the regeneration temperature was 100° C.

FIG. 8 compares the total forward and absorbed powers along with desorption capacity and absorbed microwave energy consumption to regenerate a kg of CO₂ under different power and flow rate conditions to achieve complete desorption processes. As can be seen from the graph, while the total forward power increased with increasing power rate for a complete desorption when the flow rates were 200 mL/min and 500 mL/min, a minimal decrease was observed in the forward power when the flow rate was 1000 mL/min. Absorbed power by the sorbent increased with increasing microwave forward power, which also resulted in an increase in the energy consumption. It is also shown in the graph that most of the forward power (more than 80%) was absorbed by the sorbent material, which makes the MW unit energetically efficient. The energy consumptions to desorb a kg of CO₂ when the powers were 15 W and 30 W were found to be 25.01 MJ and 27.18 MJ, respectively. Ellison et al. (Ellison, C., et al., 2021) explained in detail the chemistry aspect of desorption rate of CO₂ from Zeolite 13X which was affected by mass transfer and diffusion. The authors claim that regardless of temperature and initial microwave power, desorption was completed in the same amount of time for all experiments. Therefore, mass transfer was found to be the rate limiting step of the desorption process. It should be noted that the energy consumption decreased significantly when the flow rate increased within the fluidization regime, as it has a negative relation with the regeneration time. The same trend was observed by Chronopoulos (Chronopoulos, T., 2016); when the flow rate increased from 100 mL/min to 150 mL/min at 70° C. regeneration temperature, the energy consumptions for dry and wet cases decreased 16% and 10%, respectively. The effect of power on the desorption capacity was also investigated here, and it was found that the desorption capacity was lower when the forward power was higher, since the time for a complete desorption was lower when the power rate was higher.

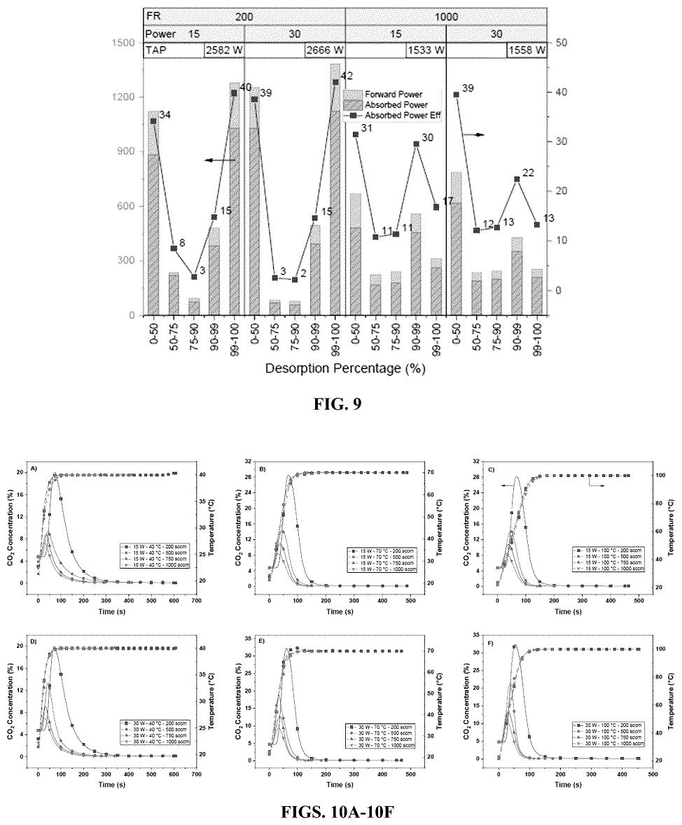

In literature, most studies have focused on the result under a complete desorption process; however, it is also crucial to investigate the results between each desorption percentage. FIG. 9 represents the results between each desorption percentage step for different flow rate and forward power with the regeneration temperature of 100° C. For example, while the total forward power was around 1200 W to desorb 50% of total desorption capacity, a total forward power of close to 200 W was consumed between 50-75% of the total desorption capacity when the flow rate and forward power were 200 mL/min and 15 W, respectively. As shown in TABLE 5, the total time to achieve a complete desorption decreased with increasing the initial forward power. While it took 465 seconds when the power was 15 W, it was 455 seconds when the power increased to 30 W at a flow rate of 200 mL/min. It is crucial to express that most of the time during the desorption process was used to remove the last 1% of the desorption capacity when the flow rate was lower. Whereas 50% of the desorbed amount has been released in 75 seconds, it took more than 250 seconds to finish the experiment between 99% and 100% of the desorption percentages. Therefore, the highest forward and reflected power usage as well as the energy consumption were observed in the last 1% of the desorption process. An increasing trend on the forward and absorbed power usage was always consistent with the initial power increase. Regardless of initial power, the lowest energy consumption was observed to be between 75-90% and 50-75% of the desorption capacities when the flow rates were 200 mL/min and 1000 mL/min, respectively. While most of the absorbed MW power (40%) was consumed in the beginning of the desorption stage, only 2% of the absorbed MW power was used to remove CO₂ between the desorption percentages of 75% and 90%. Some of the trends were also similar when the flow rate was 1000 ml/min. Desorption time was significantly lower when the flow rate was 1000 ml/min compared to 200 ml/min. Similarly, a decrease in desorption time (from 141 s to 115 s) was observed when the forward MW power increased from 15 W to 30 W.

TABLE 5
Energy consumption and desorption time for different flow rates and powers at 100° C.

| | Energy Consumption (MJ/kg CO₂) | | | | Desorption Time (s) | | | |
|---|---|---|---|---|---|---|---|---|
| Desorption | 200 (Nml/min) | | 1000 (Nml/min) | | 200 (Nml/min) | | 1000 (Nml/min) | |
| Percentage (%) | 15 W | 30 W | 15 W | 30 W | 15 W | 30 W | 15 W | 30 W |
| 0-50 | 17.2 | 21.3 | 8.3 | 11.4 | 75 | 60 | 45 | 36 |
| 50-75 | 8.5 | 2.6 | 5.8 | 7.1 | 18 | 17 | 15 | 12 |
| 75-90 | 4.6 | 4.1 | 10.4 | 13.6 | 19 | 17 | 16 | 12 |
| 90-99 | 40.3 | 44.6 | 44.4 | 38.1 | 100 | 98 | 38 | 31 |
| 99-100 | 1000.0 | 1144.5 | 222.4 | 198.0 | 253 | 263 | 27 | 24 |
| 0-100 | 25.1 | 27.2 | 13.4 | 14.8 | 465 | 455 | 141 | 115 |

Although the effects of power on energy consumption as well as desorption time are noteworthy, the main effect here was found to be due to flow rate.

Flow Rate Effect: Flow rate is one of the most important parameters in this study as fluidization effect is also investigated here to increase the energy efficiency of the desorption process. Fluidization can increase the heat transfer rate from five to ten times higher than packed-bed rectors. Furthermore, the continuous movement of particles in the fluidized bed reactors not only improves heating uniformity but also minimizes thermal runaway (Cui, Y., et al., 2020). In this study, the required flow rate corresponding to the minimum fluidization velocity was found to be between 133 mL/min and 265 ml/min for the particle diameters of 177-250 μm, respectively. The flow rate varied from 200 ml/min to 1000 mL/min which is about 4 times higher than the minimum fluidization flow rate.

This section discusses not only the CO₂ concentrations and temperature profile through the desorption process, but also desorption capacity as well as the effects of flow rate on the forward and absorbed power, energy consumption and desorption time. FIGS. 10A-10F show the CO₂ concentrations and temperature profiles under different experimental conditions. It is shown in all graphs that an increase in the flow rate resulted in lower CO₂ concentrations with time for all different regeneration temperatures and initial forward MW power cases due to the fact that the mass transfer in the fluidized bed reactors was significantly faster compared to packed bed reactors. While the maximum CO₂ concentration was obtained as 28% when the flow rate was 200 mL/min at 15 W and 100° C. regeneration temperature, a CO₂ concentration of 8% was observed when the flow rate was 1000 ml/min. As expected, the concentrations were always higher when the initial MW power was higher since the breaking of chemical bonds is faster with higher MW powers. Another important result here is that the concentrations of CO₂ were quite similar for both 70° C. and 100° C. regeneration temperatures.

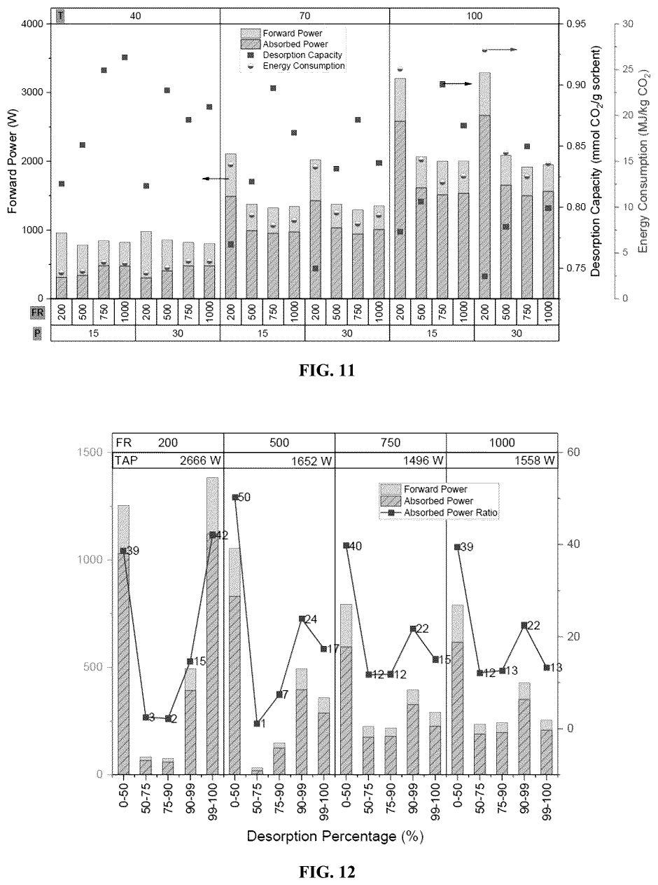

A detailed comparison of total forward and absorbed powers along with desorption capacity and energy consumption is shown in FIG. 11. It is notable that regeneration temperature here also played a significant role in the total absorbed power, and there were two different trends for the absorbed power with flow rate effected by the regeneration temperature. While the total absorbed power increased with increasing the flow rate when the regeneration temperate was set to 40° C., the absorbed power decreased with increasing flow rate when the regeneration temperatures were 70° C. and 100° C. It is notable that the fluidization phenomenon enhanced heat transfer, which resulted in lower forward absorbed power with higher flow rates. It should be noted that the lowest total absorbed power for both 70° C. and 100° C. regeneration temperature cases was obtained at 750 mL/min flow rate. It was estimated that when the flow rate was 1000 mL/min, the bed height increased slightly higher than the cavity, which might have resulted in non-uniform heating in the reactor. Although it was not easy to obtain a consistent trend when the regeneration temperature was 40° C. and power was 15 W due to the fact that most of the forward power was reflected, the results were quite consistent for higher temperatures. However, even in lower temperature cases, total absorbed power was found to be always higher than reflected power when fluidization took place in the reactor.

The desorption capacity also increased with increasing the flow rate due to higher mass and heat transfer. For example, while the desorption capacity was 0.76 mmol CO₂/g sorbent when the flow rate was 200 mL/min, it was 0.90 mmol CO₂/g sorbent when the flow rate increased to 750 ml/min. The effect of flow rate on the energy consumption (MJ/kg CO₂) to regenerate a kg of CO₂ was also compared as shown in FIG. 11. The lowest energy consumption of 2.84 MJ/kg CO₂ was obtained at 200 mL/min with a regeneration temperature of 40° C. The main reason here is that the required energy to reach 40° C. is quite low compared to higher temperatures, which resulted in lower energy consumption. However, these results were for a complete desorption process, which can change with different regenerations percentages. While the energy consumption increased with increasing flow rate when the regeneration temperature was 40° C., it decreased when the temperature was higher. The energy consumptions were obtained as 14.6 and 8.0 MJ/kg CO₂ when the flow rates were 200 and 750 mL/min, respectively, at 70° C. regeneration temperature.

FIG. 12 and TABLE 6 compare the total forward and absorbed MW powers, desorption time, energy consumption and absorbed power ratio with different flow rates and desorption percentages in the case of forward power and regeneration temperature of 30 W and 100° C., respectively. As can be seen from the figure that the total absorbed MW power (TAP) decreased with increasing flow rate from 2666 W to 1496 W when the flow rate changed from 200 mL/min to 750 mL/min since the desorption process was about 4 times faster when the flow rate was 750 ml/min. Moreover, the lowest absorbed power was obtained when the flow rate was 750 mL/min. As explained earlier, it was estimated that some of the sorbent material may not have been exposed to the microwave radiation, as some of the sorbent might have been pushed outside of the reaction zone when the flow rate was 1,000 mL/min. On the other hand, the desorption time significantly reduced from 455 s to 115 s with an increase in the flow rate from 200 ml/min to 1,000 mL/min.

TABLE 6
Energy consumption and desorption time for different flow rates at 100° C.

| Desorption | Energy Consumption (MJ/kg CO₂) | | | | Desorption Time (s) | | | |
|---|---|---|---|---|---|---|---|---|
| Percentage | 200 | 500 | 750 | 1000 | 200 | 500 | 750 | 1000 |
| (%) | (Nml/min) | (Nml/min) | (Nml/min) | (Nml/min) | (Nml/min) | (Nml/min) | (Nml/min) | (Nml/min) |
| 0-50 | 21.3 | 15.7 | 10.7 | 11.4 | 60 | 40 | 37 | 36 |
| 50-75 | 2.6 | 0.7 | 6.0 | 7.1 | 17 | 10 | 12 | 12 |
| 75-90 | 4.1 | 8.0 | 11.2 | 13.6 | 17 | 12 | 12 | 12 |
| 90-99 | 44.6 | 45.1 | 31.2 | 38.1 | 98 | 61 | 36 | 31 |
| 99-100 | 1144.5 | 278.7 | 199.6 | 198.0 | 263 | 53 | 34 | 24 |
| 0-100 | 27.2 | 16.0 | 13.3 | 14.8 | 455 | 176 | 131 | 115 |

Investigation of results with different regeneration percentages was also performed. As can been from FIG. 12, when the flow rate was 200 mL/min, the time and absorbed MW energy to remove the last 1% CO₂ were obtained as 263 s and 1121 W, respectively. In the same flow rate conditions, the first 50% regeneration took place in 60 s with absorbing a microwave power of 1028 W. The lowest MW power absorption was obtained between the regeneration percentages of 75% and 90% when the flow rate was 200 mL/min. The advantage of flow rate increase with the help of fluidization not only decreased the desorption time for a complete process, but also decreased the required MW power. During the fluidization process, most of the MW power was consumed to remove the first 50% CO₂ from the sorbent. Under the flow rate of 1000 mL/min, while the time to remove the first 50% CO₂ was 36 seconds with an absorbed power of 790 W, it took 24 seconds to remove the last 1% of CO₂ by absorbing 254 W. It is quite notable that the fluidization enhanced the heat transfer within the sorbent which resulted in more homogeneous heat transfer with lower desorption time and absorbed energy. The energy consumption to regenerate a kg of CO₂ was found to be 27.2 MJ and 13.3 MJ when the flow rate was 200 mL/min and 750 mL/min, respectively. However, it should be noted that this energy consumption could be reduced to 9.4 MJ/kg CO₂ when the desorption was finished at 75% regeneration percentage. Another important point here is that the lowest energy consumption for all cases was obtained on the desorption percentages between 50-90%. The most disadvantageous part of lower flow rates (packed bed reactors) is their high energy consumption to remove the last 10% of the CO₂ from the sorbent.

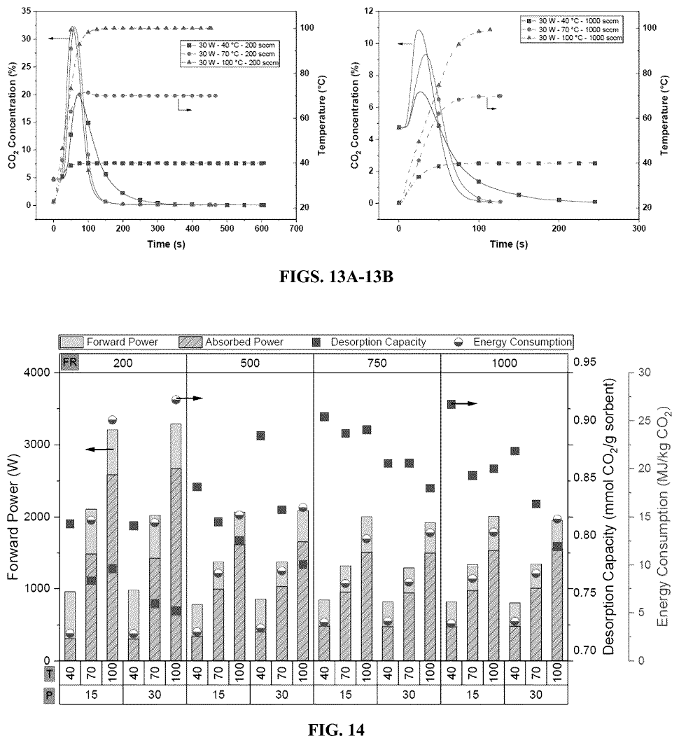

Effect of Desorption Temperature: Regeneration temperature plays a significant role in the CO₂ desorption processes, especially in the desorption time and energy consumption. Although most studies consider the regeneration temperature around 100° C., there exist several studies which proved that desorption processes can also take place with the temperature range around 50° C.-100° C. (Ellison, C., et al., 2021) (Bougie, F. et al., 2018) (Chronopoulos, T., 2016). In this study, the regeneration temperature varied between 40° C. and 100° C. As explained earlier, in the MW unit, initial forward power and desired regeneration temperature was fixed. Once the temperature reached the target regeneration temperature, the unit adjusted the power to maintain the set temperature as shown in FIG. 4. FIGS. 13A-13B illustrate the CO₂ concentrations along with the temperature profiles for different regeneration temperatures and flow rates at 30 W MW initial power. While the CO₂ concentrations were obtained close to 32% when the regeneration temperatures were set to 70° C. and 100° C. at 200 mL/min flow rate, it was obtained as 20% when the temperature was 40° C. due to low microwave absorption, which caused a delay in the desorption process. Interestingly, a complete desorption was achieved in this study even when the regeneration temperature was 40° C. The only drawback is that the time to achieve a complete desorption takes relatively longer compared to higher regeneration temperatures, especially at lower flow rates. The effect of temperature is more notable during the fluidization with the flow rate of 1000 mL/min. The CO₂ concentration was higher when the regeneration temperature was 100° C. since the desorption started earlier (faster mass transfer) because of higher absorbed microwave power to reach the target temperature.

FIG. 14 compares the total forward and absorbed power with different regeneration temperatures at different flow rates and initial forward microwave powers. The first notable trend here is that when the regeneration temperature increased, the total forward and absorbed power also increased to achieve a complete desorption process. The main reason here relies on higher energy requirements to reach higher regeneration temperatures. While a microwave power of 307 W was absorbed by the sorbent when the temperature was set to 40° C. at 200 mL/min flow rate conditions, it increased to 2582 W when the temperature changed to 100° C. The absorbed energies in these conditions were 2.84 MJ/kg CO₂ and 25.1 MJ/kg CO₂ for the regeneration temperatures of 40° C. and 100° C., respectively. Increasing flow rate to 500, 750, and 100 ml/min at 40° C. resulted in a slight increase in the energy consumption to 3.0, 4.0, and 3.86 MJ/kg CO₂, respectively. Although energy consumption for the regeneration process increased with fluidization for low regeneration temperature conditions, the desorption time decreased significantly. While a complete desorption was achieved at 608 s when the flow rate was 200 mL/min, it was completed in 250 s when the flow rate increased to 1,000 mL/min. Another important point here is that the effect of temperature on energy consumption was more notable when the flow rates were lower compared to higher flow rates. When the temperature was changed from 40° C. to 100° C., energy consumption increased from 2.8 to 27.2 MJ/kg CO₂ (10 times increment) when the flow rate was 200 mL/min, whereas energy consumption increased from 4.1 to 14.8 MJ/kg CO₂ (3.5 times increment) at the flow rate of 1,000 mL/min. Furthermore, one of the main drawbacks of lower flow rates is lower microwave efficiency. As shown in FIG. 14, while only 32% of forward power was absorbed by microwave when the temperature was 40° C. at 200 mL/min, the ratio of absorbed power to the forward power was more than 57% when the flow rate increased to 750 ml/min. It was proved that fluidization in the reactor increased the absorption of microwave for all regeneration temperature cases, especially at low temperatures.

While a consistent trend was not observed for the regeneration capacity with temperature, the energy consumption to release a kg of CO₂ always increased with increasing regeneration temperature. The desorption capacity here varied between 0.74 to 0.92 mmol CO₂/g sorbent, and it decreased with increasing temperature as desorption process took longer time with lower regeneration temperature.

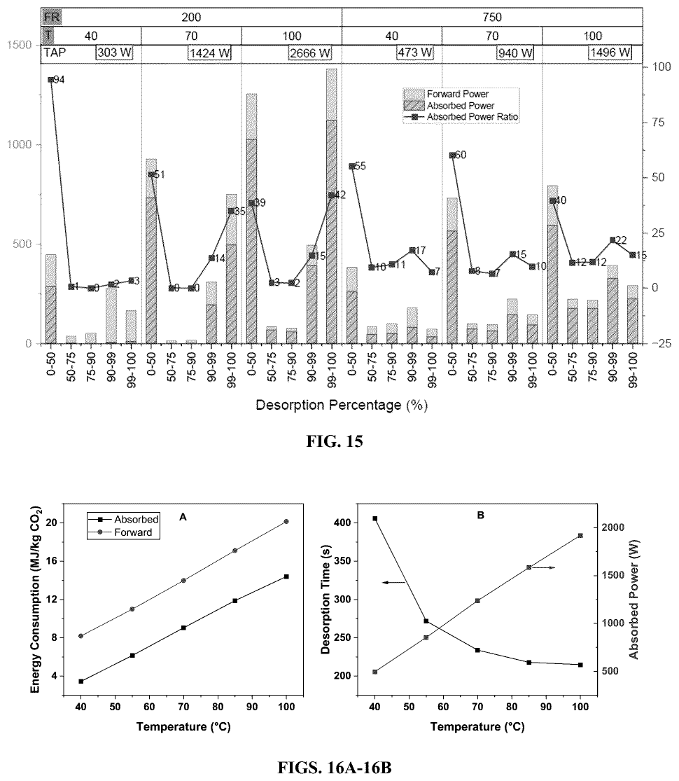

A detailed comparison of total forward, absorbed power and absorbed power ratio as well as energy consumption and desorption time through desorption process under several temperature and flow rate conditions is shown in FIG. 15, TABLE 7, and TABLE 8. It can be seen from the figure and table that the absorbed microwave power to remove the first 50% of CO₂ increased with increasing temperature. The ratios of absorbed power to remove 50% of the desorbed CO₂ were obtained as 94%, 51%, and 39% when the temperatures were 40° C., 70° C., and 100° C., respectively with the flow rate of 200 mL/min. The microwave efficiency at 40° C. with low flow rate was not very efficient since most of the microwave was reflected. Comparing the results under the regeneration temperatures of 70° C. and 100° C. at 200 mL/min, while 51% of the absorbed power was used in the first 50% CO₂ regeneration percentage when the temperature was 70° C., most of the absorbed power was consumed in the last 1% CO₂ removal when the temperature increased to 100° C.

TABLE 7
Energy consumption for different flow rates and temperatures at 30 W.

| Desorption | Energy Consumption (MJ/kg CO₂) | | | | | |
|---|---|---|---|---|---|---|
| Percentage | 200 (Nml/min) | | | 750 (Nml/min) | | |
| (%) | 40 (° C.) | 70 (° C.) | 100 (° C.) | 40 (° C.) | 70 (° C.) | 100 (° C.) |
| 0-50 | 5.3 | 14.8 | 21.3 | 4.5 | 9.7 | 10.7 |
| 50-75 | 0.1 | 0.0 | 2.6 | 1.6 | 2.6 | 6.0 |
| 75-90 | 0.0 | 0.0 | 4.1 | 3.0 | 3.7 | 11.2 |
| 90-99 | 0.5 | 21.4 | 44.6 | 7.9 | 14.2 | 31.2 |
| 99-100 | 9.3 | 504.7 | 1144 | 30.8 | 84.4 | 199.6 |
| 0-100 | 2.8 | 14.4 | 27.2 | 4.1 | 8.2 | 13.3 |

TABLE 8
Desorption time for different flow rates and temperatures at 30 W.

| Desorption | Desorption Time (s) | | | | | |
|---|---|---|---|---|---|---|
| Percentage | 200 (Nml/min) | | | 750 (Nml/min) | | |
| (%) | 40 (° C.) | 70 (° C.) | 100 (° C.) | 40 (° C.) | 70 (° C.) | 100 (° C.) |
| 0-50 | 95 | 67 | 60 | 54 | 42 | 37 |
| 50-75 | 37 | 16 | 17 | 33 | 12 | 12 |
| 75-90 | 53 | 17 | 17 | 49 | 15 | 12 |
| 90-99 | 269 | 115 | 98 | 103 | 41 | 36 |
| 99-100 | 154 | 253 | 263 | 41 | 30 | 34 |
| 0-100 | 608 | 468 | 455 | 280 | 140 | 131 |

TABLE 7 and TABLE 8 compares the energy consumption and desorption time throughout the desorption process for different temperature cases. The most energy consumption was found to remove the last 1% of CO₂ from the sorbent in all conditions, especially when the flow rate was lower and regeneration temperature was higher. One of the most important results in this study is that in the case of regeneration temperature of 40° C. with fluidization provided very effective results although the time to achieve a complete desorption took about twice compared to process when the temperature was at 100° C. As can be seen from FIG. 15, TABLE 7, and TABLE 8, the energy consumption can be reduced to 4.1 MJ/kg CO₂ if the flow rate is either 750 or 1,000 mL/min with the regeneration temperature of 40° C.

The effect of regeneration temperature on the energy consumption, desorption time and power has been illustrated in FIGS. 16A-16B. While three different temperatures (40, 70, and 100° C.) were investigated in the rest of the study, here two additional experiments with the temperatures of 55° C. and 85° C. were also performed to systematically investigate the desorption effects of the regeneration temperature. As can be seen from FIG. 16A, both absorbed and forward energy consumptions increase with increasing the desorption temperature. The main reason here is that when the temperature is set to higher values, the exposure of microwave power is higher not only to reach the desired temperature, but also to maintain this temperature. FIG. 16B also supports this statement by showing the total absorbed power for different regeneration times. It should be noted that the desorption process is completed in all temperature conditions, and all captured CO₂ is being released from the sorbent material. The only disadvantage of the low temperature desorption process is to take longer time to achieve a complete desorption as shown in FIG. 16B.

Energy Consumption Comparison with the Literature: Several studies have investigated the potential of Zeolite 13X for CO₂ desorption processes. However, one of the main criteria in these processes is the required energy to regenerate the adsorbate. Jiang et al. (Jiang, N., et al., 2020) calculated the optimized regeneration energy consumption of CO₂ desorption using Zeolite 13X as 6.76 MJ/kg CO₂. Merel et al. (Merel, J., et al., 2008) (Mérel, J., et al., 2006) claim the specific heat consumption of CO₂ desorption with Zeolite 13X as 6 MJ/kg CO₂ and 7.9 MJ/kg CO₂ in two different experimental works. A minimum energy consumption of 3.87 MJ/kg CO₂ within a short period of regeneration time was obtained under the fluidization regime with the flow rate of 1,000 Nml/min at 40° C. in this present study.

Another comparison has been made following Yassin et al. (Yassin, M. M., et al., Separation and Purification Technology, 2021). The authors compared conventional and microwave heating for CO₂ regeneration of Zeolite 13X under 15% adsorption concentration. The authors summarized that the amount of microwave power (2035.12 W/g_{sorbent}) consumed to regenerate a gram of Zeolite is 6.5 times higher than conventional heating (314.17 W/g_{sorbent}). In this study, with the help of fluidization and microwave heating, the amount of energy spent to regenerate a gram of 13X was found to be 160.33 W/g_{sorbent} and 503.67 W/g_{sorbent} under the regeneration temperatures of 40° C. and 100° C., respectively. Although the energy consumption here was found to be more than 75% less than the compared study (Yassin, M. M., et al., Separation and Purification Technology, 2021); it should be noted that these two studies differentiate in terms of the type of microwave unit and condition of adsorption CO₂ concentration.

### Discussion

Microwave technology usage for desorption applications began in 1981 by Roussy and Chenot (Roussy, G. et al., 1981) to desorb water from Zeolite 13X. In recent years, a good number of studies have investigated the microwave swing adsorption processes for CO₂ desorption. McGurk et al. (McGurk, S. J., et al., 2017) performed an experimental work to compare the desorption characteristics of aqueous monoethanolamine using conventional and microwave heating. The authors found that while regeneration was achieved at the temperature range of 120-140° C. with conventional heating, it was achieved at lower temperatures (70-90° C.) under microwave irradiation which resulted in reduction in the energy consumption and cost. Another study conducted by Bougie et al. (Bougie, F. and X. Fan, 2018) investigated the effect of microwave heating varying several parameters such as amine concentration, regeneration temperature and initial microwave power to evaluate regeneration efficiency, recovered CO₂ amount and energy consumption. The authors claim that a regeneration temperature of 90° C. was found to provide the best performance in terms of energy consumption. While the initial microwave power was also found to be 100 W to achieve the target regeneration temperature, increasing initial microwave power slightly reduces the energy consumption. Li et al. (Li, Y., et al., 2020) performed experimental work to compare the energy consumption, and regeneration efficiency of a CO₂ desorption process of two non-aqueous solutions using both microwave and conductive heating. Under the conditions of 800 W, while the energy consumption decreased by 76%, the CO₂ recovery increased 2.7 times when microwave is used for regeneration process.

As stated earlier, a variety of solid sorbent materials (zeolite 13X, MOF, activated carbon, silica gel) have been investigated under microwave irradiation for CO₂ desorption. Some of the pioneer studies in this field were performed by Chronopoulos et al. (Chronopoulos, T., 2016) (Chronopoulos, T., et al., Microporous and Mesoporous Materials, 2014) (Chronopoulos, T., et al., Energy Procedia, 2014). The authors used activated carbon as a sorbent material in a packed bed, and varied flue gas composition, gas flow rate, regeneration temperature and moisture presence. It was claimed that while the performance efficiency of the sorbent enhanced 10%, the Microwave Swing Adsorption (MSA) technology reduced the regeneration time and energy consumption by 30% and 40%, respectively, compared to the TSA process. Furthermore, the authors found that the microwave regeneration process is four times faster than that of conventional heating. Ellison et al. (Ellison, C., et al., 2021) investigated the effects of regeneration temperature and microwave power on the desorption characteristics for a post combustion process under microwave and conventional heating conditions. The authors found that the regeneration time is at least twice faster using microwave technology compared to traditional heating. It was also claimed that microwave regeneration increased the adsorption/desorption cycling productivity and reduced the energy penalty of temperature swing capture from 41.5 KJ/mol to 16-19 KJ/mol. Meloni et al. (Meloni, E., et al., 2021) performed experimental work to find optimal operation conditions for CO₂ desorption of Zeolite 13X at 300° C. under microwave irradiation. The authors obtained a 75% energy efficiency with a perfect repeatability of the results which proved that no modification took place in zeolites after microwave irradiation. Webley and Zhang (Webley, P. A. et al., 2014) performed a proof-of-concept experiments to investigate the effect of microwave to desorb CO₂ from Zeolite 13X under wet and dry conditions. The authors found that the addition of microwave not only improved the CO₂ purity up to 80% but also improved the time of the CO₂ and water desorption. Another recent study conducted by Yassin et al. (Yassin, M. M., et al., Journal of Environmental Chemical Engineering, 2021) also investigated the effect of humidity on the adsorption and desorption processes of flue gas using Zeolite 13X and Norit R2030CO2 (activated carbon) under microwave conditions. The authors evaluated the effect of parameters on the time of full regeneration, CO₂ capture capacity, recovery, purity, and desorption kinetics. It was found that the microwave assisted regeneration process provided higher CO₂ purity, recovery and productivity compared to traditional heating. The time needed to achieve 50, 80, 90, and 99% regeneration was also investigated here. They claim that to remove the last 9% of the adsorbate remaining in the sorbent while half of the desorption time was spent in TSA, it was a third of total regeneration time in the microwave-assisted process. It was also suggested here that regenerating 90% of these adsorbents instead of 99% can decrease the energy consumption and desorption time dramatically. Rueda et al. (Gomez-Rueda, Y., et al., 2022) performed experiments using a multimode microwave for CO₂ desorption process using activated carbon for post-combustion applications. While the desorption was achieved extremely fast within 79 seconds, the authors stated that the adsorption bed was not heated uniformly due to hot spots in the multimode MW cavities.

Microwave assisted desorption processes are also being used for Direct Air Capture (DAC) systems to remove CO₂ from atmospheric air. Schagen et al. (van Schagen, T. N. et al., 2022) compared traditional and microwave swing desorption process for DAC systems using Lewatit VP OC 1065 in a fixed and moving bed. While the productivity was found to be 1.5 CO₂/kg_{sorb}/d, the total energy duty varied between 25 and 50 MJ/kg CO₂. Although microwave system improved the productivity, the authors claim that more homogenous electric field could be created as several hot spots were observed due to non-homogenous electric field in the setup. Ji et al. (Ji, T., et al., 2023) also investigated the kinetics and activated energy of desorption system under microwave conditions for a DAC unit, and the activation energy can be reduced to 20-28 kJ/mol with microwave irradiation. An interesting claim has been done here that the temperature difference between adsorption and desorption process can be as low as less than 10° C. which means that the desorption can take place when the temperature of the sample is close to 40° C. Li et al. (Li, S., et al., 2021) (Li, S. and F. Gallucci, 2022) performed two experimental works to investigate the effect of plasma in the desorption of CO₂ using hydrotalcite. The experiments have been conducted under two different CO₂ concentrations: 50% and 400 ppm (to simulate direct air capture conditions). The effect of discharge power and gas flow rate on the desorption process was examined and power was claimed to have more effect. However, the energy efficiency of the proposed system was found be lower than 1%. Therefore, the authors suggested using microwave radiation in order to increase the energy efficiency higher than 50%. A recent comprehensive review published by An et al. (An, K., et al., 2023) on the regeneration strategies for direct air capture also claimed that regeneration energy demand can be reduced by microwave heating technology.

In this study, an experimental setup has been built using a mono-mode microwave unit. As discussed earlier, although multimode microwaves are capable of achieving a complete desorption process, there is a substantial possibility of having hot spots in multimode microwave units (Gomez-Rueda, Y., et al., 2022) (van Schagen, T. N. et al., 2022). The effect of flow rate, regeneration temperature and microwave initial power have been varied to investigate their effects on the desorption characteristics and energy consumption. The advantages of the disclosed study are as follows:
i) Most of the studies on CO₂ desorption applying both TSA and MSA processes used a packed bed reactor. In this study, a fluidized bed reactor has been used instead of packed bed or moving bed which not only creates more homogenous temperature distribution but also enhances the heat transfer within the sorbent as well as more efficient gas-solid contact (Cherbański, R. et al., 2009). Cherbanski and Molga (Cherbański, R. et al., 2009) reviewed the potential of microwave systems on the desorption processes. Several reactor and bed types have been discussed and claim that fluidized bed adsorbers may perform better than fixed-bed reactors to generate more homogenous temperature distribution. Cui et al. (Cui, Y., et al., 2020) provided the advantages of fluidized bed technology such as; improving heating uniformity, minimizing thermal runaway, maturity of the technology which has been used in power generation and drying processes. The authors also claim that the microwave-assisted fluidized bed prevents hot spots (localized heating) in the medium.
ii) Although several studies have discussed the energy consumption of the microwave swing desorption process very briefly, there is not a detailed study that focused on the total microwave energy absorbed by the sorbent under different conditions.
iii) A detailed investigation of desorption time and energy consumption has been done by dividing the desorption percentages (50%, 75%, 90%, 99%, 100%).
iv) While magnetrons were used for the microwave assisted desorption processes in the literature, a solid-state microwave generator has been used in this study which provides accurate power delivery, frequency tuning, and reflected power measurement.

In this study, a series of experiments have been performed to investigate the effect of fluidization along with regeneration temperature and microwave power on the characteristics of desorption processes of Zeolite 13X using a mono-mode microwave unit. While flow rate varied between 200 mL/min and 1,000 mL/min, regeneration temperature changed from 40° C. to 100° C. Forward initial microwave power also varied between 15 W and 30 W with the increment of 5 W. The effects of those parameters on the adsorption and desorption capacities, energy consumption, total forward and absorbed power usage, desorption time and CO₂ concentration have been discussed in detail.

The main findings of this study are as follows:
1) While adsorption capacity changed from 0.84 to 1.20 mmol CO₂/g sorbent, the desorption capacity varied between 0.74 and 0.92 mmol CO₂/g sorbent.
2) While temperature was found to be the most dominant parameter on energy consumption, flow rate affected most the desorption time.
3) Complete desorption was achieved for all regeneration temperatures, even at 40° C. However, desorption times were significantly higher when the flow rates were lower at this temperature.
4) Energy consumption varied between 2.84 MJ/kg CO₂ and 27.17 MJ/kg CO₂. Although the lowest energy consumption was found under the conditions of 200 mL/min at 40° C. regeneration temperature, the desorption time was quite high. Moreover, the microwave efficiency (absorbed power ratio to forward power) was quite low when the flow rate and regeneration temperature was lower as most of the forward power was reflected.
5) Fluidization enhanced the heat transfer within the sorbent which resulted in more homogeneous heat transfer with lower desorption time and absorbed energy. The energy consumption can be reduced to 3.87 MJ/kg CO₂ with a significantly less desorption time when the flow rate was set to 1,000 mL/min at 40° C.
6) Whereas an increase in the energy consumption due to fluidization was observed for low regeneration temperature conditions, a decrease was obtained for higher regeneration temperatures.
7) Most of the energy was consumed to remove the last 1% of CO₂ remaining in the sorbent when the flow rate was lower.
8) The lowest energy consumptions were observed between 75-90% and 50-75% of the desorption percentages when the flow rates were 200 mL/min and 1000 mL/min, respectively.
9) The lowest energy consumption for all cases was obtained on the desorption percentages between 50-90%. The most disadvantage part of lower flow rates was their high energy consumption to remove the last 10% of the CO₂ from the sorbent.
10) It was proved that fluidization in the reactor increased the absorption of microwave for all regeneration temperature cases, especially at low temperatures.

This study illustrated how microwave assisted fluidization affects the CO₂ regeneration process with the other two parameters. It also proved that lower flow rate with lower regeneration temperatures reduce energy consumption; however, increase the desorption time significantly. Therefore, desorption process with high flow rate within the fluidization regime at 40° C. is recommended in this study to keep the energy consumption as low as possible with a faster desorption.

### Example 2: Experimental Microwave Assisted Direct Air Capture of CO₂ under Fluidized Bed Conditions

The CO₂ concentration in the atmospheric air fluctuated between 200 and 300 ppm for 800,000 years; while it has reached more than 420 ppm in the last century with an increment of 35% (Gurkan, B., et al., 2021). The main reason for these increment was due to the rapid surge in industrial and transportation activities (Quang, D. V., et al., 2023). It is predicted that the average global temperature of the earth will increase more than 2° C. in the next two decades unless significant actions are taken to minimize greenhouse gas (GHG) emission (Bouaboula, H., et al., 2024). In order to combat CO₂ emissions, several technologies have been developed especially for power plants since they are the major contributors of the global CO₂ emissions (Olivier, J. G., et al., 2012). Despite the fact that the technologies on the carbon dioxide removal of CO₂ capture from post-combustion applications have been developing for more than 70 years, CO₂ removal from atmospheric air gain attention recently (Gurkan, B., et al., 2021).

Direct air capture concept has been first introduced by Lackner et al. (Lackner, K., et al., 1999). However, there was not a significant development on the DAC technologies due to several reasons: i) due to its high energy intensity, ii) low amount of public funding for carbon capture storage and DAC applications. For instance, United States provided cumulative funding of $3.7 billion (26 years) and only $11 million (11 years) for carbon sequestration and DAC, respectively (Hezir, J., et al., 2019) (Casaban, D., et al., 2022). However, in recent years, there is a significant attention to DAC technologies not only from industry but also from governments. Biden administration announced a $3.5 billion program to capture carbon pollution from the air. The concept in this program is to establish Regional Direct Air Capture Hubs for Large-Scale CO₂ removal throughout the country. On the other hand, the total numbers of patent applications and number of publications increased to 140 and 90, respectively in the year of 2020 (Ozkan, M., 2021). Sodiq et al. (Sodiq, A., et al., 2023) conducted a comprehensive review on the progress of DAC of CO₂. According to their bibliometric analysis using the keywords related to direct air capture on the web search engines of Scopus and Web of Science, almost 2000 scientific papers were published from 2002 to 2022. The authors also claim that most of the research studies have been conducted on the design of air contactors and regeneration methods to minimize energy consumption. While there are two pioneering DAC companies (Carbon Engineering and Climeworks) in industrial scale (Kaneko, Y., 2022), over 50 startup focusing on DAC has also been reviewed by Wang et al. (Wang, E., et al., 2024). It is evident from the interest of industry, government, and academia on the research, development, and implementation of DAC units; it will gain more attention in the next ten years which will have a significant contribution to the net-zero energy and net-zero or negative CO₂ emission targets.

There are different technologies for CO₂ capture; however, the majority of the research related to DAC applications have been performed on adsorption systems (temperature and/or vacuum swing adsorption) due to their high CO₂ equilibrium loading, fast kinetics, and stability (van Schagen, T. N., et al., 2022) (Shi, X., et al., 2020) (Yu, Q., et al., 2017). Although mature technologies on the post-combustion carbon capture have been tested by several researchers (Nikulshina, V., et al., 2009) (Keith, D. W., et al., 2018) (Brilman, D. and R. Vencman, 2013) for capturing CO₂ from the air, the cost of carbon capture with these methods are quite high due to very low CO₂ concentration levels in the atmosphere (Quang, D. V., et al., 2023). Energy consumption is also one of the most key factors in the consideration cost of DAC units. The current technologies require 5-10 GJ of energy to capture a ton of CO₂; which should be reduced to the specific energy requirement levels by integration of alternative sources to fossil fuels (i.e., solar, wind, geothermal) to DAC units (Gurkan, B., et al., 2021). Since the most energy intensive part of direct air capture process is the regeneration stage; more focus and work is required on the regeneration technologies and the sorbent material. Regarding the sorbent materials for DAC units; amine-based solids, metal-organic frameworks (MOFs), activated carbon, silica gels, cellulose, zeolites, and carbon nanotubes are the mostly tested materials by several research groups (Sodiq, A., et al., 2023) (Ozkan, M., et al., 2024) (Ozkan, M., et al., 2022). Since the scope of this work does not focus on the material, there is not a detailed discussion about solid or liquid sorbent in this study. However, several research groups have published extensive reviews on the materials for DAC of CO₂ (Bouaboula, H., et al., 2024) (Sodiq, A., et al., 2023) (Wang, E., et al., 2024) (Shi, X., et al., 2020) (Ozkan, M., et al., 2022) (Wang, X. and C. Song, 2020).

Bouaboula et al. (Bouaboula, H., et al., 2024) classified the DAC technologies into five categories; liquid scrubbing, solid sorbent, electrochemical, membrane, and cryogenic. Temperature-vacuum swing adsorption (TVSA) process under the category of solid sorbent is the most common method which has been tested extensively (Ellison, C., et al., 2021). The working principle of TVSA relies on two stages: adsorption and desorption. While the CO₂ in the air is adsorbed into the porous sorbent material during the adsorption process until the sorbent is saturated with CO₂ molecules, the captured CO₂ is released in the desorption process by applying a heat source. In traditional TVSA processes, the heat is provided by either passing steam or heated an inert gas or joule heating (Erguvan, M. and S. Amini, Separation and Purification Technology, 2024). However, the thermal energy requirement of these methods are quite high due to heat losses and significant energy demand for steam production or heating an inert gas (Ellison, C., et al., 2021). Schellevis and Brilman (Schellevis, H. and D. Brilman, 2024) performed experimental study to investigate the energy consumption and productivity of a TVSA DAC process using supported-amine sorbent. The authors found the energy consumption to capture a kg of CO₂ as 14.5 MJ/kg CO₂ with a CO₂ production capacity of 0.27 kg CO₂/kg/d. Another experimental work was carried out by Wilson and Tezel (Wilson, S. M. and F. H. Tezel, 2020) to examine the potential of seven different commercial Zeolites for the DAC of CO₂. It was concluded here that Zeolites can be good candidates for DAC applications in low humidity level environments since Zeolites can also capture water from the environment easily, thus, cause reduction in the adsorption capacity. The thermal energy requirement was found to be 9.45 MJ/kg CO₂ under 116° C. regeneration temperature conditions. Regarding energy requirements of Zeolite based DAC system, Fu and Davis (Fu, D. and M. E. Davis, 2023) performed extensive technoeconomic analysis supported by experimental results. The authors designed four different bed configurations and calculated the energy requirement for dry and humid conditions. It was found that while conventional pure zeolite-based systems require 200 MJ/kg CO₂ under humid conditions, the energy requirement they have conducted could be as low as 18 MJ/kg CO₂ under dry conditions. The authors also suggested decreasing the energy requirement of humid conditions to 71 MJ/kg CO₂ by using Mordenite-type zeolite along with desiccant wheels and SAPO-34 for bulk and trace water removal.

Due to the high energy requirements of DAC units, an alternative method for the regeneration process by using microwave technology has started to gain attention (Fu, D. and M. E. Davis, 2023). In contrast to conventional heating, microwave heats a material by dielectric and volumetric heating (energizing molecules via ionic conduction and dipole rotation) which can overcome the major issues related to low thermal conductivity and thermal losses (Jang, G. G., et al., 2023) (An, K., et al., 2023). Another advantage of microwave heating is that it can have super high heating rate which not only reduces energy requirement but also heating time. While there are a good number of studies who investigated the potential of microwave technology on post-combustion carbon capture; there are only a few studies that focused on DAC applications. A research group in Oak Ridge National Laboratory tested a proof-of concept using a multimode microwave unit to desorb CO₂ from Methylglyoxal-bis(iminoguanidine) MGBIG carbonates where BIG (Bis(iminoguanidine)) carbonate crystallization is combined with a traditional aqueous solvent to absorb CO₂ from air relatively fast (Jang, G. G., et al., 2023). The authors evaluated the feasibility of microwave heating in terms of power requirement, radiation time, and sorbent mass loss. It was found here that microwave heating is 17 times faster than conventional heating at 160° C. with a reduction of 40% electrical energy requirement. The energy requirement for a total regeneration varied between 10.2 and 30.0 KJ/g CO₂. Although microwave heating was found to be advantages in this study, the authors also stated that due to the formation of hot spots, sorbent degradation was observed. Hence, it is quite important to have uniform heating in the microwave units which can be provided by monomode microwave and fluidized bed reactors (van Schagen, T. N., et al., 2022) (Erguvan, M. and S. Amini, Separation and Purification Technology, 2024). A recent study performed by Lim et al. (Lim, T. H. et al., 2024) to explore the feasibly of microwave heating for DAC applications using Zeolite 13X beads as a sorbent. The regeneration temperature was selected close to 50° C., and a successful regeneration has been achieved in 10 minutes due to selective heating near the CO₂ binding sites. It was claimed here that even the desorption time and duration can be reduced once more uniform heating is applied. Ji et al. (Ji, T., et al., 2023) reported a microwave-accelerated regeneration of sorbent for carbon capture from atmospheric air under near-isothermal conditions at near room temperature. The authors have used carbamate and found the working capacity and activation energy ranges as 0.6-1.4 mmol/CO₂/g and 20-28 KJ/mol, respectively. In order to create a uniform bulk temperature, a magnetic bar was used with a stirrer. It was summarized here that microwave assisted desorption can enhance both productivity and energy efficiency with the help of targeted heating of CO₂ binding sites and selective desorbing CO₂ with near room temperature heating of bulk temperature. Schagen et al. (van Schagen, T. N., et al., 2022) performed an experimental work to present a proof-of-concept of a radial flow microwave unit using a commercial supported amine sorbent (Lewatit VP OC 1065) in a fixed or moving bed configuration. The authors calculated the productivity and total energy duty to capture and regenerate a kg of CO₂ as 1.5 kg CO₂/kg/d and 25 MJ, respectively. Like the other discussed studies, it was suggested that more homogenous electric field distribution in the bed can enhance the efficiency of the process due to local hot spots within the reactor which caused thermal degradation of the sorbent. To the best of the authors' knowledge, there is no other study than discussed here which has focused on the DAC of CO₂ under microwave conditions.

The first study on the regeneration of sorbents using microwave was carried out by Roussy and Chenot (Roussy, G. and P. Chenot, 1981). The authors used Zeolite 13X and investigated the effect of microwave on the water desorption of the sorbent material. Several research groups in the last decade have also investigated the effects of microwaves on the desorption process for post-combustion applications. A research group in the University of Edinburgh did extensive work applying monomode microwave heating for regeneration processes using aqueous and non-aqueous solutions under 100° C. (Bougie, F. et al., 2019) (Bougie, F. and X. Fan, 2018) (McGurk, S. J., et al., 2017). Chronopoulos et al. (Chronopoulos, T., 2016) (Chronopoulos, T., et al., Microporous and Mesoporous Materials, 2014) (Chronopoulos, T., ct al., Energy Procedia, 2014) performed experiments to evaluate the effect of several different parameters on the microwave-assisted desorption process by simulating the exhaust gases of a gas fired and coal fired power plants with the CO₂ concentrations of 5% and 15%, respectively. The authors compared microwave desorption with the conventional desorption process and observed significant reductions on the regeneration time (30%) and energy consumption (40%) under microwave conditions. Similar results have been found by Ellison et al. (Ellison, C. et al., 2021) that regeneration process time can be at least twice faster under dielectric heating conditions than that of traditional regeneration. Yassin et al. (Yassin, M. M., et al., Journal of Environmental Chemical Engineering, 2021) (Yassin, M. M., et al., Separation and Purification Technology, 2021) conducted microwave desorption experiments using activated carbon and Zeolite 13X for carbon capture from post-combustion. The authors varied several parameters to understand their effect on the desorption characteristics and compare them with conventional heating. Purity, productivity, and recovery have also been evaluated here and found greater performance under microwave conditions as opposed to traditional heating.

In this example, a new experimental monomode-microwave assisted fluidized bed setup has been built to investigate the microwave assisted desorption behavior of CO₂ under DAC conditions for proof-of-concept. While the same experimental setup has been used to capture and desorb CO₂ by simulating the exhaust gas of a gas fired power plant (Erguvan, M. and S. Amini, Separation and Purification Technology, 2024), this study uses air instead of flue gas. The first goal of this work is to use a fluidized bed reactor instead of a packed bed to create a uniform temperature environment inside of the bed (Gomez-Rueda, Y., et al., 2022). Although it was claimed that the performance of microwave heating for regeneration process is greater than conventional heating, several concerns have been raised in the literature about potential hot spot formation in the reactors due to non-homogeneous heating in the microwave units (van Schagen, T. N., et al., 2022) (Jang, G. G., et al., 2023) (An, K., et al., 2023) (Ji, T., et al., 2023) (Gomez-Rueda, Y., et al., 2022). While higher desorption rate and lower heats of adsorption were claimed due to hot spots, it is also possible to observe 100-200° C. higher temperature at local points compared to bulk temperature (Gomez-Rueda, Y., et al., 2022) (Yang, Z., et al., 2017). Therefore, it is important to avoid hotspots in the reactor to create homogenous temperatures in the reactor bed (van Schagen, T. N., et al., 2022) (Gomez-Rueda, Y., et al., 2022). Another goal of the study is based on the power characteristics of the microwave unit and adsorption material. While conventional microwave units use magnetron to create microwave, the experimental unit in this proposed work uses a solid-state microwave generator along with a mono-mode microwave cavity which allows one to measure forwarded, reflected, and absorbed microwave powers. There is also a lack of information in the literature regarding those three power parameters for regeneration processes not only for DAC, but also for post-combustion processes. The third goal relies on the experimental conditions for the regeneration process at near-room temperature through the volumetric heating of MW. In the current DAC applications, steam is the main heat supplier; hence most studies use 100° C. as regeneration temperature. While a few recent studies have worked on the regeneration temperature ranges between 40° C. and 100° C., there is not a study in the literature coupling fluidized bed with microwave heating. Microwave initial power and temperature have been varied to investigate their effect on the desorption characteristics, energy requirement, and desorption kinetics of a DAC unit.

### Methods

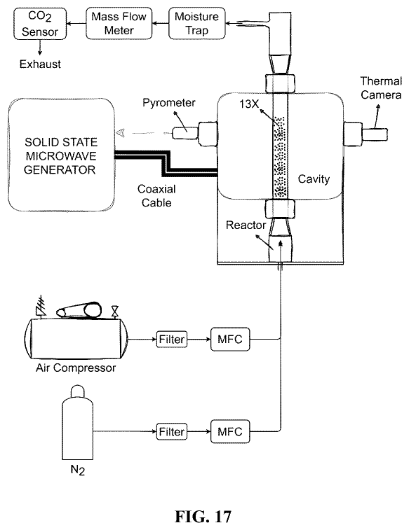

Experimental Setup: FIG. 17 demonstrates the experimental setup used for CO₂ adsorption and desorption processes under DAC conditions. Zeolite 13X with an average particle size of 213.5 μm purchased from Sigma Aldrich (20305) was selected as a sorbent. So as to remove any volatiles (CO₂, H₂O, etc.) from the sorbent, 3 gr of samples were kept overnight in a muffle furnace (Thermo Fisher Scientific) at 350° C. A custom-made (designed and fabricated by the University of Alabama glass blowing facility) borosilicate glass reactor with an inner and outer diameter of 16 and 18 mm, respectively, was used for all experiments. For the regeneration process, a compact microwave unit (MicroChem, Sairem Corp.) comprised of a solid-state microwave generator and a cavity was used. The generator and cavity were connected to each other via a coaxial cable. In contrast to microwave generators using magnetron as a microwave source, solid-state microwaves can adjust frequency with a frequency synthesizer to maximize the absorbed power by the sample. The MicroChem unit is capable of changing the frequency from 2400 to 2500 MHz under the power limitations of 0 to 200 W. A metal stub on the top of the cavity was manually adjusted to minimize the reflected power. The temperature control of the sample was performed by a pyrometer (Optris CT LT 22, ±1° C.) which was also connected to the microwave generator unit not only to read the temperature but also to adjust the forward power based on regeneration temperature. It should be noted that the pyrometer measures the temperature of the reactor surface from the front view of the cavity.

Mass flow rates of the air and N₂ to feed the reactor were controlled by two mass flow controllers (MKS GE50A, 0-1000 Nml/min for N₂, and 0-5000 Nml/min for air, ±1%). A mass flow meter (Omega FMA-1620A-I2, 0-1 SLM, ±0.8%) was used to measure the flow rate of the leaving gas from the reactor. CO₂ concentration of the outlet steam was measured by a non-dispersive infrared (NDIR) CO₂ sensor (K30 FR Fast Response 10,000 ppm CO₂ Sensor, CM-0126, ±30 ppm). In order to prevent any potential damage to the mass flow meter and CO₂ sensor, a moisture trap (CM-0103) and a filter were connected to the outlet of the reactor. Data acquisition of forward, reflected, and absorbed power, temperature, mass flow rate and CO₂ concentration for one-second intervals were made by GeneLink (provided by Sairem for the microwave unit) and Lab VIEW.

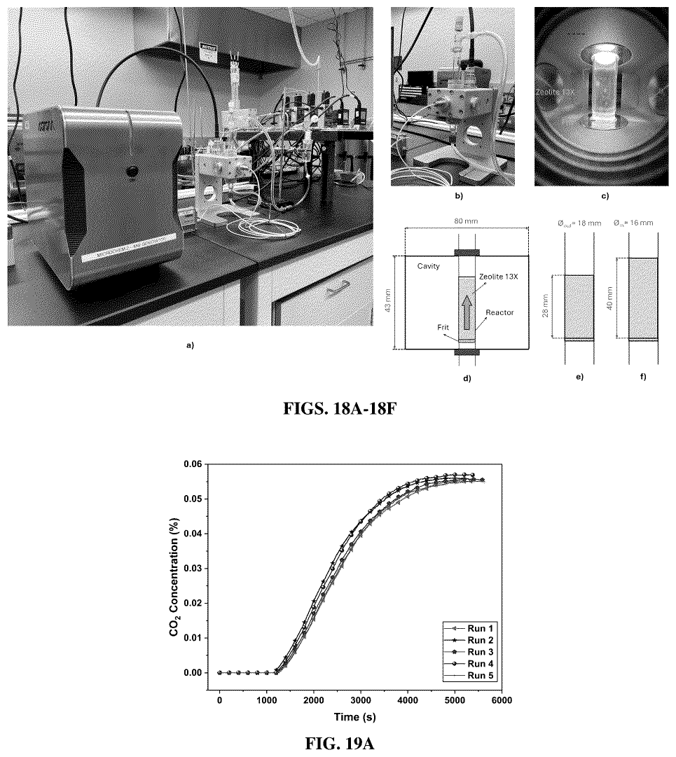

FIGS. 18A-18F illustrate a detailed overview of the reactor and cavity. As can be seen from FIG. 18D that the dimension of the microwave cavity is 43×80 mm. The borosilicate glass reactor (16 mm ID, and 18 mm OD) is located in the middle of the cavity with bed heights of 28 mm and 40 mm under the initial and fluidization conditions, respectively. It should be noted that the adsorbent material sits on the frit and the position of the reactor was fixed aligned to be in the center of the cavity in order to receive homogenous microwave absorption throughout the sample. One of the main advantages of the unit is the usage of monomode system which can transfer the microwave more stable inside the cavity compared to multi-mode systems which results in higher heating rates than that of multimode units (Chronopoulos, T., 2016).

Experimental Procedure: In this example, twelve DAC experiments have been performed in three stages (pre-treatment, adsorption, and desorption). Before the pre-treatment step, preparation of the microwave unit for PID controller and stub adjustment for minimum reflected power was carried out by operating the microwave unit at 30 W and 100° C. For this process, three grams of 13X were placed into the reactor. Once this initialization of the microwave unit was completed, the 13X in the reactor was replaced with fresh ones which were kept in the muffle furnace at 350° C. overnight. Since the sorbent contacts with the environment while filling it into the reactor, pre-treatment was applied by microwave at 100° C. for 5 minutes with 100 Nml/min N₂ flow. Then, during the adsorption stage, the feeding gas at ambient temperature was switched to dry air with a flow rate of 750 mL/min to create fluidized bed conditions. Adsorption is completed within two hours once the sorbent is saturated with CO₂. So as to start the regeneration step, while the feeding gas was switched to N₂ with a total flow rate of 750 mL/min, the microwave unit turned on by applying different power and regeneration temperature conditions as listed in TABLE 9. The temperature and power values in the table represent the regeneration temperature and microwave initial powers. It should be emphasized that the listed power is not constant and changes when the desired regeneration temperature is reached via a PID controller in the MicroChem unit. Experiments for all conditions were completed when the CO₂ sensor reached 30 ppm.

TABLE 9
Experimental conditions.

| Exp. No | Flow Rate | Power | Temperature |
|---|---|---|---|
| 1-3 | 750N ml/min | 4 W | 33-50-100° C. |
| 4-6 | | 8 W | 33-50-100° C. |
| 7-9 | | 16 W | 33-50-100° C. |
| 10-12 | | 30 W | 33-50-100° C. |

Calculation Methods for Minimum Fluidization Velocity, Working Capacities, and Energy Consumption: A goal of the example study relies on the fluidization of the sorbent material to enhance the heat transfer homogeneity and temperature within the reactor under microwave conditions. According to Cocco et al. (Cocco, R., et al., 2014), fluidization can increase the heat transfer rate five to ten times compared to packed bed reactors. As stated earlier, the average particle size used in this study is 213.5 μm with a particle density of 640 kg/m³. Following the minimum fluidization velocity equations from Cocco et al. (Cocco, R., et al., 2014), Wen and Yu (Wen, C. Y. and Y. H. Yu, 1966), it was found here that the minimum flow rate to have fluidization conditions should be 200 mL/min. More detailed information about calculations and bed height increment can be found in (Erguvan, M., and S. Amini, Separation and Purification Technology, 2024).

In order to investigate the effect of different parameters on the desorption characteristics; several performance indicators need to be calculated, such as, adsorption and desorption capacities, energy consumption as well as productivity and desorption kinetics along with activation energy. While adsorption capacities (q_{ads}) were calculated by integrating the CO₂ flow rate between inlet and outlet of the reactor, the desorption capacities (q_{des}) were calculated by integrating CO₂ flow rate of the leaving gas from the reactor (Erguvan, M. and S. Amini, Carbon Capture Science & Technology, 2024).

$${q}_{a d s} = \frac{{ρ}_{{CO}_{2}}}{m} {\int }_{0}^{{t}_{a d s}} ( {Q}_{i n} {C}_{i n , {CO}_{2}} - {Q}_{out} {C}_{out , {CO}_{2}} ) d t$$

This equation represents the adsorption capacity which is the amount of captured CO₂ per gram of sorbent (mmol CO₂/g_{sorbent}. Here, p, m, Q and C are the density of carbon dioxide, mass of sorbent, volumetric flow rate of the inlet and outlet gasses of the reactor and the CO₂ concentrations, respectively. To calculate desorption capacity, following equation is used:

$${q}_{des} = \frac{{ρ}_{{CO}_{2}}}{m} {{\int }_{0}}^{{t}_{des}} {Q}_{out} {C}_{{CO}_{2}}^{out} ( t ) dt$$

Once capacities are defined, the absorbed energy requirement (EC (MJ/kg CO₂)) to regenerate a kg of CO₂ can be calculated by the following equation (Erguvan, M. and S. Amini, Separation and Purification Technology, 2024) (Bougie, F., et al., 2019):

$$EC = \frac{{E}_{a b s} ( MJ )}{{q}_{{CO}_{2}} ( kg )} = \frac{{\int }_{0}^{{t}_{d e s}} {P}_{a b s} ( t ) d t}{m \times {q}_{d e s}}$$

where E_{abs} (MJ), P_{abs} (W), m (g) denote absorbed microwave energy by the sorbent, absorbed microwave power per unit time and mass of sorbent, respectively. As discussed in detail in (Erguvan, M. and S. Amini, Separation and Purification Technology, 2024), all microwave related powers; forward, reflected, and absorbed powers are measured by the MicroChem unit.

$${P}_{a b s o r b e d} = {P}_{f o r w a r d s} - {P}_{r e f lected} - {P}_{l o s s}$$

where forward is the microwave power provided by the generator, and the reflected power is measured by resistance element which is dissipated by an isolator. The power losses in the MW unit are estimated to be 0.1 dB with the known losses in the cables and connectors. The calculation method of productivity and desorption kinetics using Avrami's model are discussed in the next section.

### Results

In this section, the effects of microwave initial powers and desired regeneration temperature on the desorption characteristics, desorption kinetics, productivity and energy consumption have been discussed in detail. It should be noted that the mentioned “energy consumption” in this section represents the thermal absorbed microwave energy consumption to regenerate a kg of CO₂.

Adsorption: After the pre-treatment of sorbent material, the adsorption process was started with a flow rate of 750 ml/min to create a fluidized bed environment. As explained earlier, air has been provided by the main compressor of the North Engineering Research Center Building at the University of Alabama. To create a uniform flow distribution in the fluidized bed reactor, a borosilicate fritz which has B type porosity (70-100 μ) has been used for the sorbent with an average particle size of 213.5 μm.

FIGS. 19A-19B show CO₂ concentration and adsorption rate with time for five different experiments. It should be noted that although the experiment conditions are different for desorption stages, the adsorption conditions for all experiments in this study are the same. Therefore, the legends in FIGS. 19A-19B called as Run for each experiment. As can be seen from the figures that the adsorption continued for more than 1.5 hours, and the breakthrough curve started to increase after 40 minutes as all CO₂ in the air was captured by the sorbent material in the beginning of the process. It should be noted that although the CO₂ sensor has provided the highest CO₂ concentration close to 450 ppm in the blank tests, it was obtained around 530 ppm when the sorbent material is in the reactor. It was estimated that the concentration in the sensor varies due to pressure change in the reactor with the fluidization. The highest adsorption rates were found to be around 3.5×10⁻⁵mmol/g sorbent. The average adsorption capacity was calculated as 0.24 mmol CO₂/g sorbent with a standard deviation of 0.024.

Desorption: The desorption of Zeolite 13X under microwave conditions relies on a selective heating process even at low temperatures (Lim, T. H., et al., 2024). Although 13X is considered to be transparent to microwaves as it consists of aluminosilicate, the large number of Na⁺ cations existence in its structure makes 13X a good microwave absorber (Ellison, C., et al., 2021) (Lim, T. H., et al., 2024). On the other hand, the surface silanol groups of Zeolite 13X coupled with electromagnetic radiation which promotes the interaction between CO₂ binding and microwave; hence, a rapid heat flow from surface to the bulk of the material (Yassin, M. M., et al., Separation and Purification Technology, 2021) (Turner, M. D., et al., 2000).

In this work, three different regeneration temperature effects (33° C., 50° C., and 100° C.) on the desorption characteristics have been investigated. Several different parameters have been analyzed not only to investigate required energy consumption for the desorption process, but also to compare desorption kinetics. The addition of fluidization characteristics to the volumetric heating of the microwave is also discussed in detail. It should be noted that the energy calculations here represent the amount of absorbed microwave energy by the sample for the regeneration process. In real processes, the mechanical energy usage by blower or compressor should also be considered which is estimated to be relatively lower compared to thermal energy.

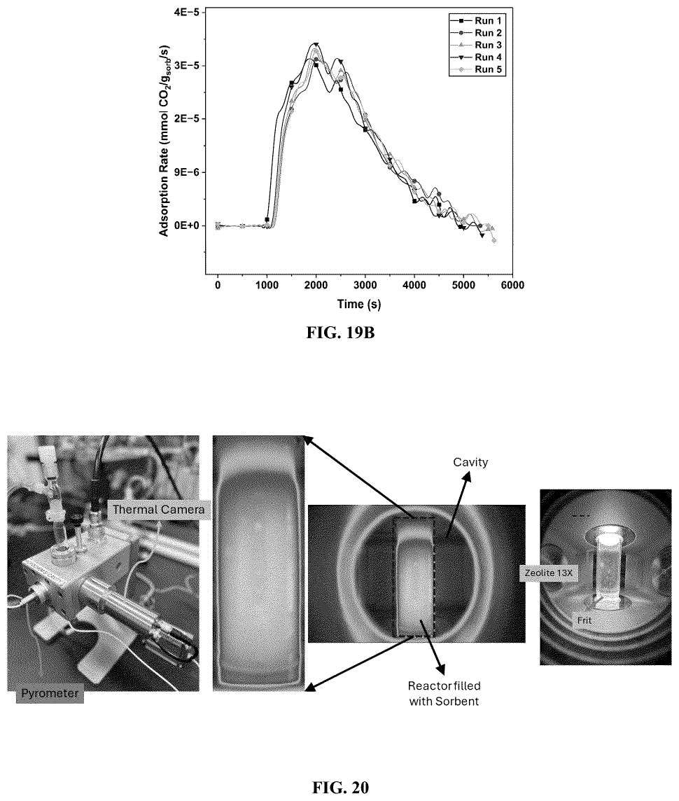

Temperature Distribution under Packed and Fluidized Bed Conditions: In microwave heating systems, temperature measurement of a sample, its fluctuation with time, and the appropriate devices for temperature monitoring are some of the most important parameters (Ramirez, A., et al., 2017) (Ramirez, A., et al., 2016) (Gangurde, L. S., et al., 2017) (Kappe, C. O., 2013) (Julian, I., et al., 2022). In this study, an infrared thermal (Optris XI 410) camera has been used to monitor the temperature distribution of the reactor surface filled with Zeolite 13X together with a pyrometer under both packed and fluidized bed conditions. As can be seen from FIG. 20 that while the thermal camera measures the temperature from the right side of the reactor, the pyrometer is located in the front side of the cavity. It should be noted that the pyrometer was the main temperature controller of the microwave unit to adjust the power to keep the desired regeneration temperature. While the MW unit is capable of measuring temperature from both fiber optic temperature probe and pyrometer; pyrometer is selected in the current study due to two reasons. First of all, while pyrometers can measure the temperature of a point or an area, probes can measure only a specific point in the reactor. Secondly, since the sorbent is bubbling due to fluidization, having a temperature probe in the reactor may change the fluidization characteristics. Furthermore, since the fiber optic sensors are extra fragile, the temperature of the sample is usually measured by an IR pyrometer in microwave applications (García-Baños, B., et al., 2019). The IR camera also shows the temperature distribution inside of the microwave cavity; however, the discussion here is focused on the reactor surface and the sorbent material.

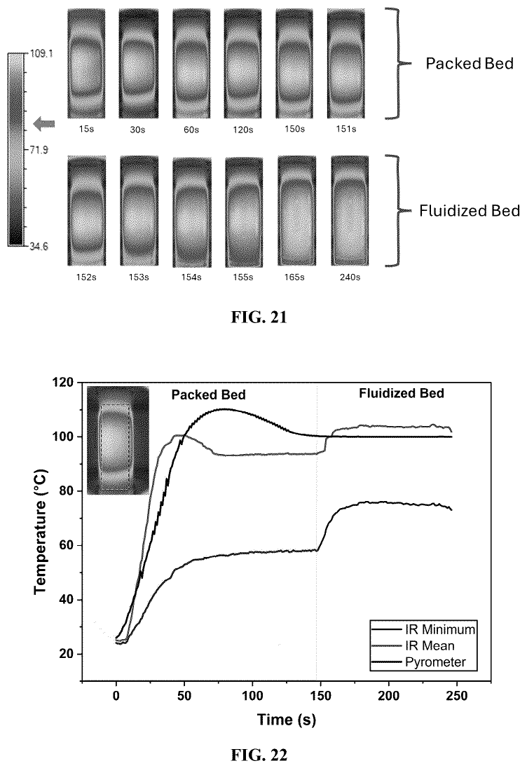

In order to obtain a homogeneous temperature distribution along the sample in MW units for regeneration processes, Cherbanski and Molga (Cherbański, R. and E. Molga, 2009) suggested using fluidized bed reactors. FIG. 21 illustrates the temperature distribution of the sorbent on the surface of the cavity under packed and fluidized bed conditions. While flow rate of the packed bed was selected as 100 mL/min, fluidized bed conditions were met under 750 mL/min gas flow conditions. The MicroChem unit was set to 100° C. regeneration temperature with 30 W initial MW power. The temperature of the sorbent reached more than 75° C. in 15 seconds when the MW was operated. Then, the MW unit reduced the power to maintain the temperature at the desired regeneration temperature (100° C.), however, an overheating of about 10° C. was observed (FIG. 22). In addition, nonhomogeneous temperature distribution can be seen in FIG. 21 under packed bed conditions that most of the heat is accumulated in the middle of the reactor. When the flow rate of the sweeping gas increased to 750 mL/min to achieve fluidization conditions at 152 seconds, the temperature values from the pyrometer became stable at 100° C. as expected. Moreover, the heat expanded throughout the reactor which created a homogeneous temperature environment in the bed. Another temperature comparison between the packed and fluidized bed was done by investigating the minimum temperature measured by IR camera for the selected area as shown in FIG. 22. The minimum temperature of the area increased immediately once the fluidized bed conditions started.

The temperature profiles and temperature distribution demonstrated in FIG. 21 and FIG. 22 that a fluidized bed is the main role player to distribute the microwave heat homogeneously throughout the sample.

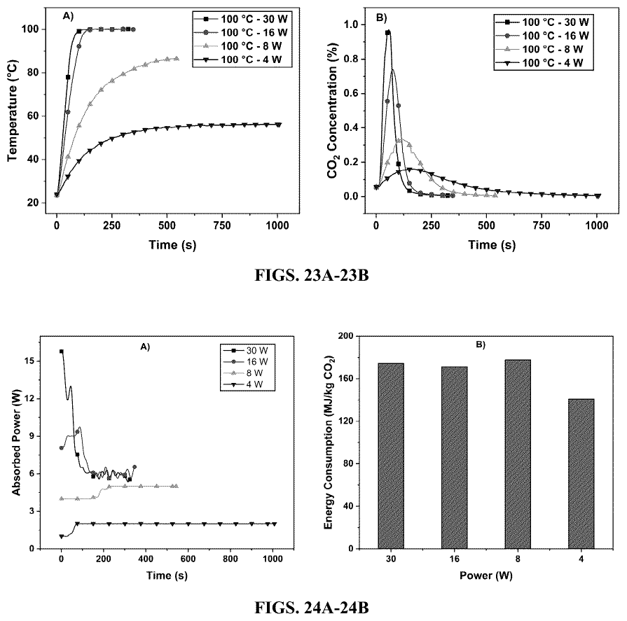

Desorption Characteristics under Standard Temperature (100° C.): FIGS. 23A-23B show the temperature and CO₂ concentration change with time for different initial MW power conditions when the regeneration temperature was set to 100° C. As expected, the highest microwave power resulted in faster desorption with the highest CO₂ concentration peak. The reason behind this phenomenon is that higher microwave power provides a higher electromagnetic field which results in more interactions between microwave and the sorbent material with more intermolecular motions and friction; hence, higher heating rate. Moreover, Zeolite 13X has a faujasite structure that has three sites (SI, SII, and SIII) which have important roles in the desorption process (Ellison, C., et al., 2021). While the physiosorbed absorbed CO₂ in SII sites can desorb at lower temperatures, higher temperature might be needed to desorb bicoordinated CO₂ in SIII sites due to stronger bonding (Ellison, C., et al., 2021) (Siriwardane, R. V., et al., 2005). However, Ellison et al. (Ellison, C., et al., 2021) claim that the captured CO₂ in these two faujasite structures were desorbed simultaneously even at lower regeneration temperatures (50° C.) due to the fact that only one peak was observed in the CO₂ concentration of the outlet gas with time. In this it is also estimated that higher temperature and power values desorb the CO₂ in all three structures relatively faster than that of lower ones which resulted in higher CO₂ concentration in the beginning of the desorption process. It should be noted that although the desired temperature was set to 100° C., the target temperatures were not reached when the initial MW powers were 4 and 8 W. While the temperature became stable at 56° C. when the power was 4W, it reached as high as 85° C. when the MW power was 8 W. The desorption capacity varied between 0.104 and 0.108 mmol CO₂/g_{sorbent} when the regeneration temperature was 100° C. Although the target temperature was not achieved for the two lowest initial power options, similar desorption capacities were obtained even at these low power conditions. It should also be noted that desorption efficiencies at 100° C. regeneration temperature conditions varied between 41.8% and 43.6%. The only disadvantage here is that the required time for complete desorption is quite high for low MW power conditions.

In DAC systems, there are two fundamental parameters; firstly, the type of sorbent material which can adsorb a good amount of carbon dioxide from atmospheric air and secondly, the energy requirement to regenerate sorbent to release captured CO₂. This study focuses on the energy requirement part of a DAC unit using Zeolite 13X which is claimed to be a good microwave absorber due to the high number of Na⁺ cations in the structure of the 13X (Ellison, C., et al., 2021) (Whittington, B. I. and N. B. Milestone, 1992). FIG. 24A and b compare the total absorbed power with time through the regeneration process and energy consumptions under different initial power rates, respectively. It should be noted that the energy consumption here represents the absorbed microwave energy by sample to regenerate a kg of CO₂. It is shown in FIG. 24A that when the initial microwave power was set to 30 W, the initial absorbed microwave power was about 16 W, and it immediately reduced since the target temperature was reached in a short period. As explained earlier, although the microwave initial power is an input in this study, the supplied forward power varies to maintain the target temperature. Therefore, the absorbed power changes from 16 W to 6 W throughout the regeneration process for 30 W MW initial power conditions. Although similar trends are noticeable when the initial power was 16 W, the absorbed power becomes almost stable between 2 and 3 W, when the power was set to 4 W. Unfortunately, this power option is not feasible when the desired temperature is selected to be more than 60° C.

Several studies have investigated the energy requirement for regeneration of CO₂ for DAC applications. Bouaboula et al. (Bouaboula, H., et al., 2024) compared different DAC technologies in terms of technical, economic and environmental aspects. The authors found that the specific energy requirements for DAC units vary between 0.9 and 102 MJ/kg CO₂. Two commercial companies, Global Thermostat and Climeworks claim the lowest energy requirement; however, the sorbent materials used in these companies are unknown. While Global Thermostat technology requires a total energy consumption of 4.98 MJ/kg CO₂, Climeworks technology requires 3.59 MJ/kg CO₂ (Kiani, A., et al., 2020). Regarding the use of Zeolite 13X for DAC applications, there are limited numbers of studies which investigated the energy consumption for the regeneration process. Marinic and Likozar (Marinič, D. and B. Likozar, 2023) listed the energy requirements for different materials and also for Zeolite in DAC operations. The authors referenced three different studies where Zeolite was used as a sorbent with the energy requirements of 29.09 MJ/kg CO₂ (Sinha, A., et al., 2022), 50 MJ/kg CO₂ (Santori, G., et al., 2018), 198.4 MJ/kg CO₂ (Zhang, Z., et al., 2022). The desorption temperatures in these studies are either 100° C. or close to this temperature. Wilson and Tezel (Wilson, S. M. and F. H. Tezel, 2020) performed an experimental study of a DAC unit using Faujasite Zeolites and obtained the energy requirement of the regeneration process as 17-18 MJ/kg CO₂. FIG. 24B compares the absorbed energy consumption to regenerate a kg of CO₂ for different microwave initial power conditions at 100° C. regeneration temperature. It was found that the energy consumption fluctuates around 170 MJ/kg CO₂. The energy consumption here is significantly higher compared to conventional DAC operations; although some studies (Zhang, Z., et al., 2022) have also obtained higher energy consumption when Zeolite was used as a sorbent. MW initial power also does not have a significant effect on the energy consumption for standard regeneration temperature of 100° C.

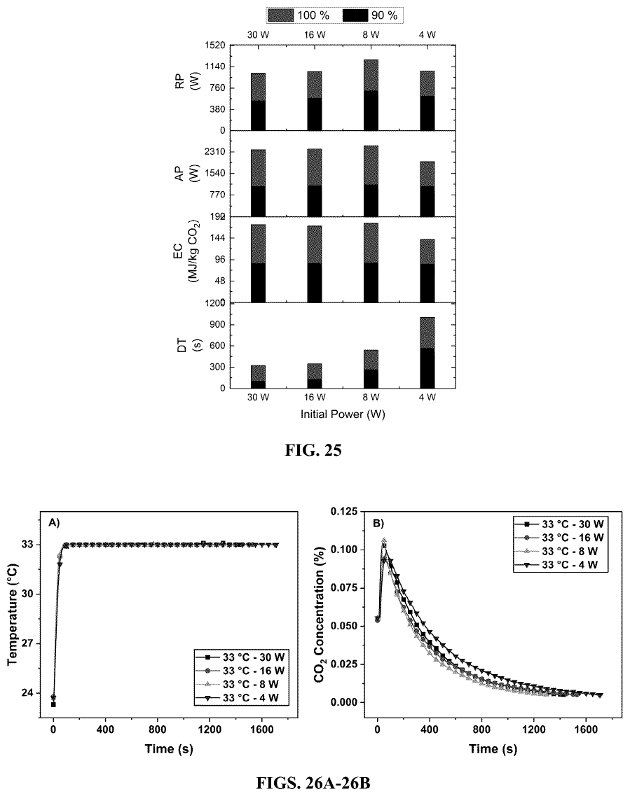

Although energy consumption and absorbed power are important parameters to investigate the desorption process, reflected power and desorption times are also quite important. FIG. 25 represents the total reflected power, absorbed power, energy requirement as well as desorption times for different MW initial power conditions. Furthermore, the results were also evaluated based on desorption percentages of 100% and 90%. While 100% represents the maximum desorption capacity for each case, 90% represents 90% of the maximum desorption capacity as suggested by (Erguvan, M. and S. Amini, Separation and Purification Technology, 2024) (Chronopoulos, T., 2016) (Yassin, M. M., et al., Journal of Environmental Chemical Engineering, 2021). The main reason here is that most of the CO₂ is desorbed in the first 50% of the desorption time. It should be recalled that the desorption is stopped/completed when the CO₂ sensor displayed 30 ppm in the leaving gas. As can be seen from FIG. 25 that there is a slight increase in the total absorbed and reflected powers when the initial MW power is reduced from 30 W to 4 W. Although it is expected to have lower energy consumption when the power is lower; this trend is not achieved in these conditions due to the fact that the desorption time is significantly higher when the initial MW power is the lowest. For example, while the desorption was completed in 300 seconds when the MW power was set to 30 W, it was completed in more than 900 seconds when the power was 4 W. It is also clear from the figure that most of the power (close to 70%) is absorbed by the sample which makes the microwave unit quite efficient compared to multimode microwave units. Alongside the mono-mode feature of the MicroChem unit, fluidization effect is also important on the microwave efficiency as the particles are moving along the reactor which also creates a more homogenous temperature environment in the bed. There is one crucial point here that if the desorption is completed when 90% of desorption is achieved the energy consumptions, absorbed power, and reflected power reduces more than 50% in all conditions. However, the effect of the 90% desorption percentage needs to be investigated in detail to understand how the next cycle will be affected in terms of adsorption and desorption capacities.

Near Room Temperature Desorption: In conventional DAC units, thermal energy (e.g., steam) is used to increase the temperature of sorbent material to desorb CO₂ within a temperature range of 80-120° C. (Ji, T., et al., 2023) (Beuttler, C., et al., 2019). Recent studies have investigated the possibility of using lower temperatures in the DAC applications than the required temperature for conventional temperature swing adsorption processes. For instance, Ji et. al. (Ji, T., et al., 2023) performed an experimental study to investigate the desorption characteristics of microwave assisted desorption process using a BIAS solid sorbent which contains silica, PEI, TMPED, and methanol. The authors used real air for the adsorption process and the regeneration process was operated under microwave power and regeneration temperatures conditions of 100 W and 40° C., respectively. It was found here that the desorption capacity varied between 0.06-0.11 mmol CO₂/g sorbent. The authors stated that microwave-accelerated regeneration of sorbent process allows one to run the adsorption and desorption processes with a temperature difference as low as <10° C. Lim et al. (Lim, T. H., et al., 2024) conducted an experimental study to investigate the feasibility of microwave technology for DAC units using Zeolite 13X with the regeneration temperature of 50° C. The authors also claimed that the temperature could be further reduced by applying more uniform heating. As explained earlier, fluidization can be a promising method to solve the inhomogeneous heating problem of microwave heating.

To recall, three different regeneration temperatures (33° C., 50° C., 100° C.) are investigated in this study. FIG. 26A indicates the temperature and CO₂ concentration variations during the regeneration process when the temperature was set to 33° C. As can be seen from the FIG. 26B that the peak was observed close to 1000 ppm during the desorption process under all power conditions. The regeneration capacities varied between 0.074 and 0.088 mmol CO₂/g Zeolite which are relatively lower compared to regeneration process of post-combustion applications; however, Ji et al. (Ji, T., et al., 2023) also obtained a similar working capacity with a range of 0.06-0.11 mmol CO₂/g sorbent.

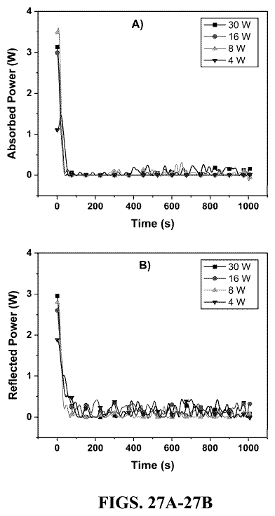

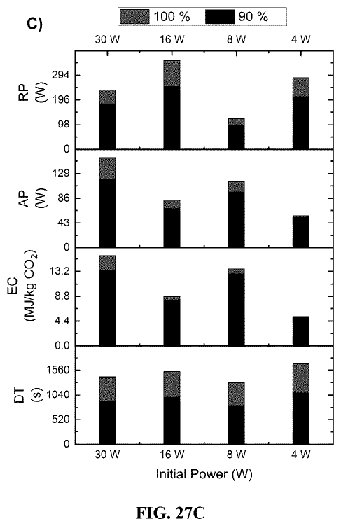

FIGS. 27A-27C compare absorbed and reflected power change with time during the desorption process as well as total absorbed, reflected powers, energy consumption and desorption time for different MW initial powers at 33° C. regeneration temperature. It should be noted that although initial MW power was expected to vary between 4 W and 30 W, the highest power was observed as 10 W due to the fact that the temperature value of 33° C. is quite low and the MW unit did not need to provide a 100% of MW initial power to heat up the sorbent material. As can be seen from the figure, after the sorbent was heated to 33° C., the absorbed and reflected power varied between 0 and 1 W. When the temperature is low, the effect of MW initial power is not noticeable since the forward microwave power immediately reduces when the temperature is close to the near-room temperature regeneration temperature. Therefore, it is not expected that there should be a trend for the results based on MW initial power rates. It was found here that the energy consumption for the regeneration process varies between 4.8 and 16 MJ/kg CO₂ under the regeneration temperature of 33° C. conditions. One key point here is that although the absorbed powers were always higher than reflected power when the regeneration temperature was 100° C., the trend is opposite when the temperature changed to 33° C. For example, the total absorbed and reflected powers were found to be 157 W and 235 W at 30 W initial microwave power conditions. Moreover, while reflected power was found to be 284 W, the total absorbed power was 56 W when the microwave power is reduced to 4 W. It is noticeable that using lower initial microwave power is less efficient compared to higher microwave powers; however, due to low temperature requirement under near-room temperature conditions, using the possible lowest initial microwave power conditions provides less energy requirement. Although reflected power is higher than absorbed power when the regeneration temperature is lower, the total forward microwave power is significantly lower than that of 100° C. desorption cases, especially for low microwave initial power conditions. It is found that fluidization has an important contribution to the case of 4 W and 33° C. which provided the lowest energy consumption in this study. Same conditions have been applied with lower flow rate of 150 mL/min without fluidization and the desorption process even were not completed after 6 hours regeneration which substantially increased the energy consumption. Desorption time for different power conditions were also found to be quite close. Furthermore, there was not a significant decrease in the absorbed energy consumption when the regeneration percentage was reduced to 90% under near-room temperature conditions.

Temperature Effect: In this section, a detailed discussion of temperature effect on the desorption characteristics of CO₂ under fluidized bed-microwave conditions is provided. As explained earlier, although MW initial powers have been varied, discussing the effects of power can be tricky since this power only represents the maximum power which is exposed to the sorbent material to achieve the desired regeneration temperature. As it will be discussed later, while some of the initial MW powers were not even reached to its maximum set point due to low regeneration temperature, some initial MW powers were also found to be insufficient to achieve the desired regeneration temperature. For instance, 30 W initial MW power was set as a possible maximum power; however, the MW unit did not even supply this power when the regeneration temperature was set to 33° C. Similarly, for the case of 100° C. regeneration temperature, 4 and 8 W MW initial power options were not sufficient to achieve this regeneration temperature.

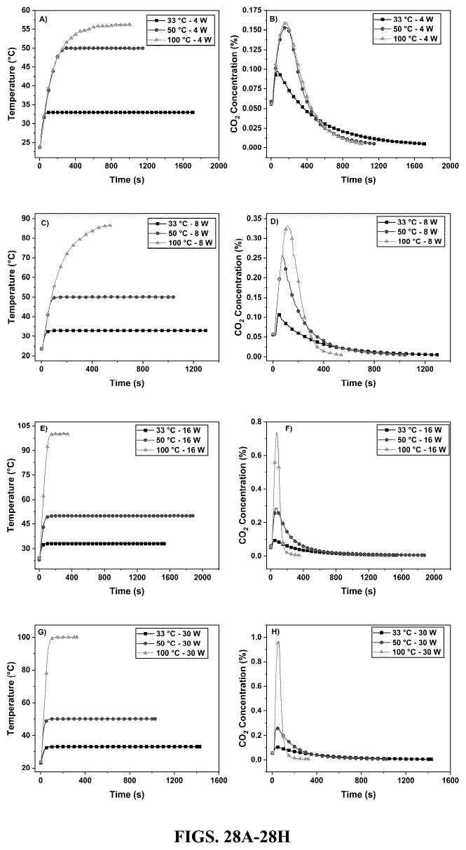

FIGS. 28A-28H shows the sorbent temperature and CO₂ concentration change with time during the desorption period just after the MW is exposed to the sample for all conditions performed in this study. As can be seen from the figure, the trends of the temperature and CO₂ concentration with time in the beginning of each experimental condition are almost identical for each regeneration temperature. For example, when the initial microwave was set to 30 W, the temperature increase of sorbent and CO₂ concentration of the released gas is very similar for the first 30 seconds in which most of the CO₂ is desorbed from the surface of the Zeolite 13X. Having a high temperature under microwave desorption conditions provide faster desorption due to the fact that the interaction between the microwave and silanol groups on the surface of Zeolite 13X increases due to higher MW power exposure to reach the desired regeneration temperature. Although having a high temperature about 100° C. seems to be an advantage because of faster desorption and higher desorption capacity expectations, they do not provide the best results regarding energy consumption which makes high temperate conditions disadvantageous. It should be noted that the desorption capacities varied in this study from 0.074 to 0.108 mmol CO₂/g sorbent which are quite close to the study performed by Ji et. al. (Ji, T., et al., 2023). It is a fact that the desorption capacities are quite low compared to post-combustion applications; however, this study is intended to provide a proof-of-concept of fluidized bed reactor for MW-DAC applications using Zeolite 13X as it is commercially available.

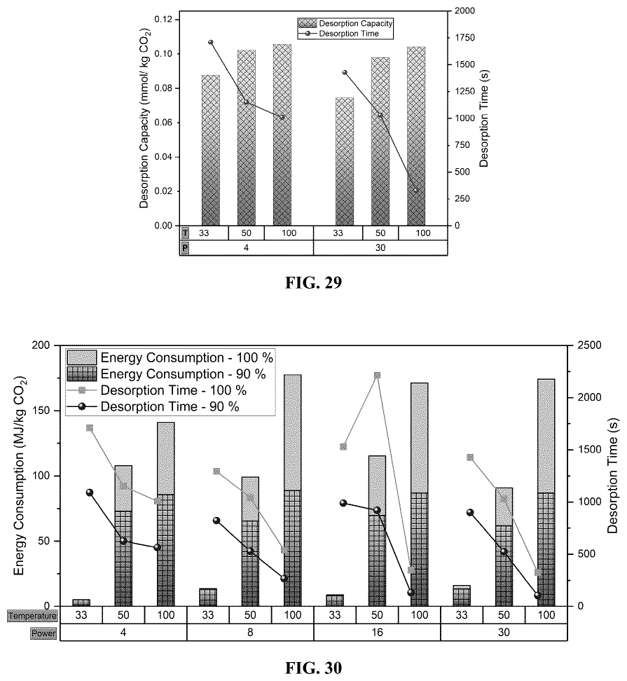

Regarding the desorption capacities, as can be seen from the FIG. 29 that they were obtained about 20% higher than that of 33° C. when the generation temperature was set to 100° C. According to the results of this study, the only advantages of using a high temperature regeneration temperature (100° C.) is that they can provide about 20% increase in the desorption capacity and a faster desorption. For instance, while the desorption was completed in 324 seconds when the temperature was 100° C., it was completed in 1428 seconds when the temperature was 33° C. under 30 W initial MW conditions.

As discussed earlier, energy consumption is one of the key factors in DAC applications and thermal energy occupies most of it due to steam requirement in the current conventional units. Although a detailed discussion has been provided in the previous section to investigate the effect of microwave power on the desorption behaviors; it sometimes might be misleading as the term microwave power represents the initial microwave power to reach the desired regeneration temperature. Therefore, another deep analysis is also important to examine the effect of temperature on the desorption characteristics under specific MW initial power conditions. FIG. 30 compares the energy consumption and desorption time for all conditions listed in TABLE 9. As can be seen here that energy consumption always increases with increasing regeneration temperature for all different power options since more power is consumed to achieve high temperature. However, other research groups (Ellison, C., et al., 2021) (Lim, T. H., et al., 2024) (Ji, T., et al., 2023) have also proved that there is no need to use high desorption temperatures for DAC applications under microwave conditions. It is noticeable here that energy consumption increases from ten to twentyfold when the regeneration temperature increases from 33° C. to 100° C. For instance, while the energy consumption was found to be 8.8 MJ to regenerate a kg of CO₂ when the temperature and power was 8 W and 33° C., it jumped to 171.3 MJ/kg CO₂ when the regeneration temperature increased to 100° C. It was also claimed by Fu and Davis (Fu, D. and M. E. Davis, 2023) that the energy consumption for regeneration of CO₂ of DAC using Zeolite 13X is about 200 MJ/kg CO₂. On the other hand, desorption time is affected significantly by the temperature not only for high MW initial powers but also for the low ones. The desorption time for high temperature (100° C.) conditions is almost 5 times faster than that of the conditions at 33° C. It should also be noted that there is an important change in energy consumption when the desorption percentage is reduced to 90%, especially for high temperature cases. For example, the energy consumption of 90% desorption percentage is almost half of 100% desorption percentage when the temperature and initial microwave power were set to 100° C. and 30 W, respectively. However, this trend is not similar for low temperature conditions due to the fact that the desorption is quite slow in this temperature and the absorbed microwave is significantly low at the end of the desorption process. It is also estimated that fluidization has a substantial effect to create a homogeneous temperature distribution in the reactor which helps low temperature conditions to consume minimal microwave power.

Productivity: Productivity is one of the key factors to evaluate the economic feasibility of a temperature swing adsorption system (Yassin, M. M., et al., Journal of Environmental Chemical Engineering, 2021); and it is calculated as follows:

$$Productivity ( \frac{{kgCO}_{2}}{{kg}_{s} d} ) = \frac{{q}_{ad , {CO}_{2}}}{t}$$

Productivity is calculated by dividing the adsorption capacity into the total cycle time. Cycle time represents the total time including adsorption and desorption times. While some studies considered different percentages of desorption (Yassin, M. M., et al., Journal of Environmental Chemical Engineering, 2021) or working capacities (Elfving, J., et al., 2021) for the desorption time, 100% desorption percentage time is used for the productivity calculations in this study.

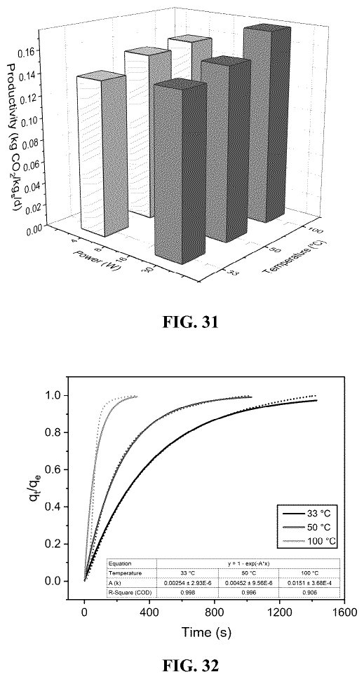

As can be seen from FIG. 31, the range of the productivity varied between 0.14 and 0.18 kgCO₂/kgₛ/d. Comparing the productivity found in this study with the literature related to direct air capture applications, very close numbers have been obtained. For example, Schellevis and Brilman (Schellevis, H. and D. Brilman, 2024) calculated the productivity as 0.29 kgCO₂/kgₛ/d with an thermal energy duty of 11.9 MJ/kg CO₂. Elfving et al. (Elfving, J., et al., 2021) claimed the productivity of 0.146 kgCO₂/kgₛ/d with a specific energy requirement of 6.4 MJ/kg CO₂. It should be noted that these productivities are based on a regeneration temperature of 100° C. It is estimated that the productivity could be lower when the desorption temperature would reduce in these studies since desorption time could be longer in lower regeneration temperatures. Schellevis and Brilman (Schellevis, M. and W. Brilman, 2022) performed another DAC experiments using amines and found the productivity and energy consumption as 0.19 kgCO₂/kgₛ/d and 19.0 MJ/kg CO₂, respectively. Schagen et al. (van Schagen, T. N., 2022) performed microwave DAC experiments using a commercial amine-based (Lewatit VP OC 1065) sorbent. Although the productivity was found in this paper as 1.5 kgCO₂/kgₛ/d; however, the authors did not include the adsorption time when calculating the productivity.

The effect of temperature and power on productivity is illustrated in FIG. 31. There is not a significant change in the productivity values when the temperature or power were varied due to the fact that the most dominant factor in the productivity is the adsorption time which is 5000 s in the experiments performed in this study. As expected, the productivity increased with increasing both temperature and power as the desorption time decreases with higher temperature and higher power rates under fluidization conditions.

Desorption Kinetics and Activation Energy: The parameters of kinetics study provide an understanding and predicting of desorption characteristics under different experimental conditions; especially in a small temperature range (Yassin, M.M., et al., Journal of Environmental Chemical Engineering, 2021) (Wang, T., et al., 2013) (Erguvan, M., et al., Energy Technology, 2024). On the other hand, activation energy (Eₐ) represents the minimum required energy to start a reaction (Wang, T., et al., 2013). In the literature, several different kinetic methods, such as, Pseudo-first order model (PFO), Pseudo-second order model (2nd order), and Avrami's Model exist. Yassin et al. (Yassin, M. M., et al., Journal of Environmental Chemical Engineering, 2021) compared all three different methods for microwave-assisted CO₂ desorption process for post-combustion applications. The authors found that Avrami's model provides the best prediction of desorption rate. In this study, Avrami's model has also been used to calculate desorption kinetics and then activation energy.

$${q}_{t} = {q}_{e} ( 1 - exp ( - k ) ) {t}^{n}$$

where qₜ (mg) and qₑ (mg) are the desorbed CO₂ amount at time t and at equilibrium, respectively. While k represents Avrami's kinetic constant (min⁻¹), t and n denote time and the Avrami's exponent, respectively. Here, it is assumed that the adsorption is homogeneous on the surface of the Zeolite particles which allow one to assume the Avrami's exponent as 1. Using Origin 2024 (OriginLab Corporation, USA), the desorption kinetics can be calculated by plotting exponential curves. FIG. 32 shows an exponentially fitted graph for different temperatures when the power was set to 30 W. As can be seen from the graph that the goodness-of-fit (R²) varies between 0.91 and 0.998, which provides quite close trends to the experimental data. Although the case of 100° C. regeneration temperature has a fast desorption, it should be expressed that the desorption under 33° C. regeneration temperature also starts immediately just after the MW is operated. This is also evident that the regeneration of 13X close to the room temperature is possible.

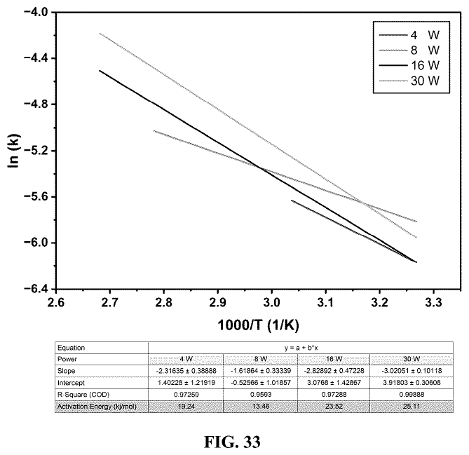

In order to evaluate the desorption kinetics deeper, the apparent activation energy (E_{act}) calculation has also been considered here by using the Arrhenius equation as follows (Ellison, C., et al., 2021):

$$ln k = ln A - \frac{{E}_{act}}{R T}$$

where A, R, and T represents the pre-exponential factor (min⁻¹), ideal gas constant (8.314 J/mol K), and the regeneration temperature (K), respectively. Activation energy and the pre-exponential factor from Arrhenius equation can be determined using intercept and slope by fitting the curve of Ink and 1/T as shown in FIG. 33.

Ellison et al. (Ellison, C., et al., 2021) stated that the activation energy should be equal or higher than isosteric heat of adsorption (adsorption enthalpy) of Zeolite 13X. Dirar and Loughlin (Dirar, Q. H. and K. F. Loughlin, 2013) reported the 13X's heat of adsorption between 28 KJ/mol and 32 KJ/mol. Guo et al. (Guo, Y., et al., 2018) investigated the kinetics of thermal desorption of CO₂ on Zeolite 13X under different heating rate conditions. The authors found that the desorption activation energy of the physisorption sites varied between 12.15 KJ/mol and 58.53 KJ/mol. As shown in FIG. 33, the activation energy values obtained in this study varied from 13.46 to 25.11 KJ/mol. It should be pointed out that the target regeneration temperature of 100° C. was not achieved when the MW initial power was set to 4 and 8W. Therefore, the evaluation of the activation energy should be made based on 16 W and 30 W MW initial powers for this study.

It is unfortunate that the literature mostly focuses on the heat of adsorption of Zeolite 13X, adsorption kinetics are rarely reported (Samanta, A., et al., 2012). To the author's knowledge, there is not a study discussing the activation energy of Zeolite 13X neither using conventional nor microwave heating for DAC applications. Ellison et al. (Ellison, C., et al., 2021) performed an experimental study to compare the activation energy of CO₂ desorption process using 13X under microwave and conventional heating for post-combustion. The authors found that while activation energy is 45 KJ/mol under conventional heating, it varies between 15-18 KJ/mol when the microwave is used for the desorption process. The desorption rates claimed to be dependent more on the mass diffusion than temperature. The activation energy obtained in this study is more than 50% lower compared to activation energy reported in the literature for post-combustion applications. The reason for this phenomenon is estimated to be that coupling of fluidizations with microwave volumetric heating created a more homogeneous temperature distribution within the reactor which has reduced the apparent activation energy.

Limitations of fluidized bed configuration for CO₂ capture processes: The gas-solid contacting system significantly affects the CO₂ capture characteristics especially during the adsorption stage. As illustrated in this paper, solid mixing in a fluidization enhances heat transfer and gas-solid contact efficiency with a quite low energy requirement for the regeneration process. Several studies also claim that fluidized bed configurations can overcome the heat transfer limitations of fixed bed reactors which makes them suitable for temperature swing adsorption processes (Raganati, F., et al., 2021) (Monazam, E. R., et al., 2013) (Yaghoobi-Khankhajeh, S., et al., 2018). Raganati et al. (Raganati, F., et al., 2021) performed an extensive review on the adsorption of CO₂ for post-combustion capture and provided detailed thermodynamic limitations of both fixed and fluidized bed reactors. The authors stated that while fluidization provides higher heat and mass transfer rates, it causes fast CO₂ breakthrough; hence, poor CO₂ working capacity. As seen in the CO₂ concentration graphs of desorption processes, the leaving gas from the reactor is highly diluted with the purge gas (N₂) which may also require additional system to separate CO₂ from the nitrogen such as using membranes (Mohammadzadeh, M., et al., 2022) (Joglekar, M., et al., 2019). A different approach under fluidized bed conditions to minimize dilution effect has been applied by a research group in Istituto di Ricerche sulla Combustione by creating a separate heating and purge regeneration strategy where the sorbent material is heated without any fluidization after the adsorption is completed (Raganati, F.,et al., 2016). Then, once the CO₂ sensor does not capture any CO₂, a purge gas (N₂) is used to desorb the remaining CO₂ in the sorbent material. The result in that study shows that this method is quite efficient when the regeneration temperature is higher than 100° C. that can recover more than 70% of the adsorbed power by the thermal effect without fluidization. However, this method is highly temperature dependent; for example, when the temperature was set to 40° C., only 20% of the CO₂ was recovered without fluidization.

### Conclusion

In this study, an experimental study has been conducted to present proof-of-concept of a microwave assisted fluidized bed regeneration process under DAC conditions. A monomode microwave generator connected to a cavity has been used for microwave heating. Microwave initial power and regeneration temperatures varied from 4 W to 30 W and from 33° C. to 100° C., respectively. The effects of these parameters on the desorption capacity, energy consumption, productivity and desorption kinetics including activation energy have been discussed. Temperature distribution along the reactor has also been investigated to compare packed and fluidized bed configurations under microwave conditions.

It was found that regeneration temperature has higher impact than microwave initial power in all experimental conditions. The importance of power is more noticeable when a high regeneration temperature of 100° C. is required. Desorption capacities were found to be quite close compared to the regeneration temperature cases of 33° C. and 100° C. However, the energy consumption at the conditions of 33° C. were found to be ten to twenty times lower than that of 100° C. with a range between 4.8 and 16 MJ/kg CO₂ while conventional pure-zeolite based system requires 200 MJ/kg CO₂ for DAC applications (Fu, D. and M. E. Davis, 2023). The desorption kinetics also demonstrated that the desorption under 33° C. regeneration temperature started immediately just after the MW is operated which proved that fluidized bed microwave conditions accelerate regeneration process. Temperature distribution results from the IR camera proved that fluidization not only creates an even temperature distribution along the sample compared to packed bed but also prevents overheating of the sorbent. Productivity of all experimental conditions changed between 0.14 and 0.18 kgCO₂/kgₛ/d which could be substantially lower unless the particles were not fluidized due to longer desorption time. This study could be a potential guide for industrial demonstration of larger scale fluidized bed DAC microwave reactors. It has been proven here that microwave assisted fluidized bed regeneration system not only create a more homogenous temperature distribution throughout the reactor but also increase the productivity as well as reduce energy consumption using near-room temperature conditions.

All patents, applications, and publications listed throughout this document are hereby incorporated by reference in their entirety herein.

### REFERENCE LIST

An, K., et al., A comprehensive review on regeneration strategies for direct air capture. Journal of CO₂ Utilization, 2023. 76: p. 102587.
Beuttler, C., et al., The role of direct air capture in mitigation of anthropogenic greenhouse gas emissions. Frontiers in Climate, 2019. 1: p. 10.
Bouaboula, H., et al., Comparative review of Direct air capture technologies: From technical, commercial, economic, and environmental aspects. Chemical Engineering Journal, 2024: p. 149411.
Bougie, F. and X. Fan, Microwave regeneration of monoethanolamine aqueous solutions used for CO₂ capture. International Journal of Greenhouse Gas Control, 2018. 79: p. 165-172.
Bougie, F., et al., Novel non-aqueous MEA solutions for CO₂ capture. International Journal of Greenhouse Gas Control, 2019. 86: p. 34-42.
Brilman, D. and R. Veneman, Capturing atmospheric CO₂ using supported amine sorbents. Energy Procedia, 2013. 37: p. 6070-6078.
Casaban, D., et al., The impact of Direct Air Capture during the last two decades: A bibliometric analysis of the scientific research part I. Sustainable Chemistry for Climate Action, 2022: p. 100009.
Change, I. C., Mitigation of climate change. Contribution of working group III to the fifth assessment report of the intergovernmental panel on climate change, 2014. 1454: p. 147.
Cherbański, R. and E. Molga, Intensification of desorption processes by use of microwaves-An overview of possible applications and industrial perspectives. Chemical Engineering and Processing: Process Intensification, 2009. 48(1): p. 48-58.
Chronopoulos, T., et al., CO₂ desorption via microwave heating for post-combustion carbon capture. Microporous and Mesoporous Materials, 2014. 197: p. 288-290.
Chronopoulos, T., et al., Utilisation Of Microwave Energy for v Desorption in Post-combustion Carbon Capture Using Solid Sorbents. Energy Procedia, 2014. 63: p. 2109-2115.
Chronopoulos, T., Microwave Swing Adsorption for post-combustion CO₂ capture from flue gases using solid sorbents, in Chemical Engineering. 2016, Heriot-Watt University. Cocco, R., et al., Introduction to fluidization. Chem. Eng. Prog, 2014. 110(11): p. 21-29.
Cui, Y., et al., Experimental fluidization performances of silicon carbide in a fluidized bed. Chemical Engineering and Processing-Process Intensification, 2020. 154: p. 108016.
Dąbrowska, S., et al., Current Trends in the Development of Microwave Reactors for the Synthesis of Nanomaterials in Laboratories and Industries: A Review. Crystals, 2018. 8(10): p. 379.
Díaz de Greñu, B., et al., Fast Microwave-Assisted Synthesis, Calcination and Functionalization of a Silica Mesoporous Nanomaterial: UVM-7. ChemSusChem, 2023. 16(12): p. e202300123.
Dirar, Q. H. and K. F. Loughlin, Intrinsic adsorption properties of CO₂ on 5A and 13X zeolite. Adsorption, 2013. 19: p. 1149-1163.
Elfving, J., et al., Experimental comparison of regeneration methods for CO₂ concentration from air using amine-based adsorbent. Chemical Engineering Journal, 2021. 404: p. 126337.
Ellison, C., et al., Comparison of microwave and conventional heating for CO₂ desorption from zeolite 13X. International Journal of Greenhouse Gas Control, 2021. 107: p. 103311.
Erguvan, M. and S. Amini, Experimental microwave assisted CO₂ desorption of a solid sorbent in a fluidized bed reactor. Separation and Purification Technology, 2024. 343: p. 127062.
Erguvan, M. and S. Amini, Parametric Investigation of CO₂ Desorption of Zeolite 13X Under Microwave Condition. Carbon Capture Science & Technology, 2024. 11: p. 100189.
Erguvan, M., et al., A Kinetic Study of Microwave—Assisted Desorption of CO₂ from Zeolite 13x. Energy Technology, 2024: p. 2301492.
Fu, D. and M. E. Davis, Toward the feasible direct air capture of carbon dioxide with molecular sieves by water management. Cell Reports Physical Science, 2023. 4(5).
Gangurde, L. S., et al., Complexity and challenges in noncontact high temperature measurements in microwave-assisted catalytic reactors. Industrial & engineering chemistry research, 2017. 56(45): p. 13379-13391.
García-Baños, B., et al., Temperature assessment of microwave-enhanced heating processes. Scientific Reports, 2019. 9(1): p. 10809.
Gomez-Rueda, Y., et al., Rapid temperature swing adsorption using microwave regeneration for carbon capture. Chemical Engineering Journal, 2022. 446: p. 137345.
Gritti, F. and G. Guiochon, Effect of the flow rate on the measurement of adsorption data by dynamic frontal analysis. Journal of Chromatography A, 2005. 1069(1): p. 31-42.
Guo, Y., et al., Desorption characteristics and kinetic parameters determination of molecular sieve by thermogravimetric analysis/differential thermogravimetric analysis technique. Adsorption Science & Technology, 2018. 36(7-8): p. 1389-1404.
Gurkan, B., et al., Perspective and challenges in electrochemical approaches for reactive CO₂ separations. Iscience, 2021. 24(12).
Hauchhum, L. and P. Mahanta, Carbon dioxide adsorption on zeolites and activated carbon by pressure swing adsorption in a fixed bed. International Journal of Energy and Environmental Engineering, 2014. 5(4): p. 349-356.
Hezir, J., et al., Carbon Removal: Comparing Historical Federal Research Investments with the National Academies' Recommended Future Funding Levels. 2019, Bipartisan Policy Center.
Houghton, J., Global Warming: The Complete Briefing. T. Edition Number 5. 2015, Cambridge University Press.
Huang, Y.-F., et al., Microwave pyrolysis of rice straw to produce biochar as an adsorbent for CO₂ capture. Energy, 2015. 84: p. 75-82.
IEA, CO₂ Emissions from Fuel Combustion 2016. 2016.
Inc., S., MicroChem User Manual. 2023.
Jang, G. G., et al., Ultra-fast microwave regeneration of CO₂ solid sorbents for energy-efficient direct air capture. Separation and Purification Technology, 2023. 309: p. 123053.
Ji, T., et al., Energy-efficient and water-saving sorbent regeneration at near room temperature for direct air capture. Materials Today Sustainability, 2023. 21: p. 100321.
Jiang, N., et al., CO₂ capture from dry flue gas by means of VPSA, TSA and TVSA. Journal of CO₂ Utilization, 2020. 35: p. 153-168.
Joglekar, M., et al., Carbon molecular sieve membranes for CO₂/N₂ separations: evaluating subambient temperature performance. Journal of Membrane Science, 2019. 569: p. 1-6.
Julian, I., et al., From bench scale to pilot plant: A 150× scaled-up configuration of a microwave-driven structured reactor for methane dehydroaromatization. Catalysis Today, 2022. 383: p. 21-30.
Kaneko, Y., Moisture-Controlled CO₂ Sorption and Membranes Actively Pumping CO₂. 2022, Arizona State University.
Kappe, C. O., How to measure reaction temperature in microwave-heated transformations. Chemical Society Reviews, 2013. 42(12): p. 4977-4990.
Keith, D. W., et al., A process for capturing CO₂ from the atmosphere. Joule, 2018. 2(8): p. 1573-1594.
Kiani, A., et al., Techno-economic assessment for CO₂ capture from air using a conventional liquid-based absorption process. Frontiers in Energy Research, 2020. 8: p. 92.

Kolle, J. M., et al., Understanding the Effect of Water on CO₂ Adsorption. Chemical Reviews, 2021. 121(13): p. 7280-7345.
Lackner, K., et al., Carbon dioxide extraction from air: is it an option? 1999, Los Alamos National Lab. (LANL), Los Alamos, NM (United States).
Li, S. and F. Gallucci, CO₂ capture and activation with a plasma-sorbent system. Chemical Engineering Journal, 2022. 430: p. 132979.
Li, S., et al., Non-thermal plasma-assisted capture and conversion of CO₂. Chemical Engineering Journal, 2021. 410.
Li, Y., et al., Screening and performance evaluation of triethylenetetramine nonaqueous solutions for CO₂ capture with microwave regeneration. Energy & Fuels, 2020. 34(9): p. 11270-11281.
Lim, T. H., et al., Microwave-based CO₂ desorption for enhanced direct air capture: Experimental validation and techno-economic perspectives. Environmental Research Letters, 2024.
Marinič, D. and B. Likozar, Direct air capture multiscale modelling: From capture material optimization to process simulations. Journal of Cleaner Production, 2023: p. 137185.
McGurk, S. J., et al., Microwave swing regeneration of aqueous monoethanolamine for post-combustion CO₂ capture. Applied energy, 2017. 192: p. 126-133.
Meloni, E., et al., Intensification of TSA processes using a microwave-assisted regeneration step. Chemical Engineering and Processing-Process Intensification, 2021. 160.
Mérel, J., et al., Carbon dioxide capture by indirect thermal swing adsorption using 13X zeolite. Environmental progress, 2006. 25(4): p. 327-333.
Merel, J., Met al., Experimental investigation on CO₂ post—combustion capture by indirect thermal swing adsorption using 13X and 5A zeolites. Industrial & Engineering Chemistry Research, 2008. 47(1): p. 209-215.
Mohammadzadeh, M., et al., Theoretical study of CO₂/N₂ gas mixture separation through a high-silica PWN-type zeolite membrane. Industrial & Engineering Chemistry Research, 2022. 61(16): p. 5593-5599.
Mohd Pauzi, M. M. I., et al., Emerging Solvent Regeneration Technologies for CO₂ Capture through Offshore Natural Gas Purification Processes. Sustainability, 2022. 14(7): p. 4350.
Monazam, E. R., et al., Fluid bed adsorption of carbon dioxide on immobilized polyethylenimine (PEI): Kinetic analysis and breakthrough behavior. Chemical Engineering Journal, 2013. 223: p. 795-805.
Nikulshina, V., et al., CO₂ capture from atmospheric air via consecutive CaO-carbonation and CaCO3-calcination cycles in a fluidized-bed solar reactor. Chemical Engineering Journal, 2009. 146(2): p. 244-248.
Nokpho, P., et al., Evaluating regeneration performance of amine functionalized solid sorbents for direct air CO₂ capture using microwave. Materials Today Sustainability, 2024. 26: p. 100728.
Olivier, J. G., et al., Trends in global CO₂ emissions. PBL Netherlands Environmental Assessment Agency, 2012. 500114022: p. 6-39.
Ozkan, M., Direct air capture of CO₂: A response to meet the global climate targets. MRS Energy & Sustainability, 2021. 8(2): p. 51-56.
Ozkan, M., et al., Forging a sustainable sky: Unveiling the pillars of aviation e-fuel production for carbon emission circularity. iScience, 2024.
Ozkan, M., et al., The status and prospects of materials for carbon capture technologies. MRS Bulletin, 2022. 47(4): p. 390-394.
Pal, A., et al., Experimental investigation of COCO₂ 2 adsorption onto a carbon based consolidated composite adsorbent for adsorption cooling application. Applied Thermal Engineering, 2016. 109: p. 304-311.
Palma, V., et al., Microwaves and heterogeneous catalysis: A review on selected catalytic processes. Catalysts, 2020. 10(2): p. 246.
Quang, D. V., et al., A review of potential routes to zero and negative emission technologies via the integration of renewable energies with CCO₂ O2 capture processes. International Journal of Greenhouse Gas Control, 2023. 124: p. 103862.
Raganati, F., et al., Adsorption of carbon dioxide for post-combustion capture: a review. energy & fuels, 2021. 35(16): p. 12845-12868.
Raganati, F., et al., On improving the CO₂ recovery efficiency of a conventional TSA process in a sound assisted fluidized bed by separating heating and purging. Separation and Purification Technology, 2016. 167: p. 24-31.
Ramírez, A., et al., Ethylene epoxidation in microwave heated structured reactors. Catalysis Today, 2016. 273: p. 99-105.
Ramirez, A., et al., In situ temperature measurements in microwave-heated gas-solid catalytic systems. Detection of hot spots and solid-fluid temperature gradients in the ethylene epoxidation reaction. Chemical Engineering Journal, 2017. 316: p. 50-60.
Rodríguez-Mosqueda, R., et al., Parametrical Study on CO₂ Capture from Ambient Air Using Hydrated K2CO3 Supported on an Activated Carbon Honeycomb. Industrial & Engineering Chemistry Research, 2018. 57(10): p. 3628-3638.
Roussy, G. and P. Chenot, Selective energy supply to adsorbed water and nonclassical thermal process during microwave dehydration of zeolite. The Journal of Physical Chemistry, 1981. 85(15): p. 2199-2203.
Samanta, A., et al., Post-combustion CO₂ capture using solid sorbents: a review. Industrial & Engineering Chemistry Research, 2012. 51(4): p. 1438-1463.
Santori, G., et al., Adsorption artificial tree for atmospheric carbon dioxide capture, purification and compression. Energy, 2018. 162: p. 1158-1168.
Schellevis, H. and D. Brilman, Experimental study of CO₂ capture from air via steam-assisted temperature-vacuum swing adsorption with a compact kg-scale pilot unit. Reaction Chemistry & Engineering, 2024.
Schellevis, M. and W. Brilman, Experimental Campaign with a 1 Kg/Day Fixed Bed DAC Unit Using Solid Amines, in Proceedings of the 16th Greenhouse Gas Control Technologies Conference (GHGT-16) 23-24 Oct. 2022. 2022.
Shi, X., et al., Sorbents for the direct capture of CO₂ from ambient air. Angewandte Chemie International Edition, 2020. 59(18): p. 6984-7006.
Sinha, A., et al., Reduced building energy consumption by combined indoor CO₂ and H₂O composition control. Applied Energy, 2022. 322: p. 119526.
Siriwardane, R. V., et al., Adsorption of CO₂ on Zeolites at Moderate Temperatures. Energy & Fuels, 2005. 19(3): p. 1153-1159.
Sodiq, A., et al., A review on progress made in direct air capture of CO₂. Environmental Technology & Innovation, 2023. 29: p. 102991.
Sylvia, N., et al. A computational fluid dynamic comparative study on CO₂ adsorption performance using activated carbon and zeolite in a fixed bed reactor. in IOP Conference Series: Materials Science and Engineering. 2019. IOP Publishing.
Turner, M. D., et al., Microwave radiation's influence on sorption and competitive sorption in zeolites. AIChE Journal, 2000. 46(4): p. 758-768.
van Schagen, T .N., et al., Development of a novel, through-flow microwave-based regenerator for sorbent-based direct air capture. Chemical Engineering Journal Advances, 2022. 9: p. 100187.

Wang, E., et al., Reviewing direct air capture startups and emerging technologies. Cell Reports Physical Science, 2024.
Wang, H., et al., Experimental and numerical study of CO₂ adsorption on Ni/DOBDC metal-organic framework. Applied Thermal Engineering, 2014. 73(2): p. 1501-1509.
Wang, T., et al., A moisture swing sorbent for direct air capture of carbon dioxide: Thermodynamic and kinetic analysis. Energy Procedia, 2013. 37: p. 6096-6104.
Wang, X. and C. Song, Carbon capture from flue gas and the atmosphere: A perspective. Frontiers in Energy Research, 2020. 8: p. 560849.
Webley, P. A. and J. Zhang, Microwave assisted vacuum regeneration for CO₂ capture from wet flue gas. Adsorption, 2014. 20(1): p. 201-210.
Wen, C .Y. and Y. H. Yu, A generalized method for predicting the minimum fluidization velocity. AIChE Journal, 1966. 12(3): p. 610-612.
Whittington, B. I. and N. B. Milestone, The microwave heating of zeolites. Zeolites, 1992. 12(7): p. 815-818.
Wilson, S. M. and F. H. Tezel, Direct dry air capture of CO₂ using VTSA with faujasite zeolites. Industrial & Engineering Chemistry Research, 2020. 59(18): p. 8783-8794.
Yaghoobi-Khankhajeh, S., et al., Adsorption modeling of CO₂ in fluidized bed reactor. Chemical Engineering Research and Design, 2018. 129: p. 111-121.
Yang, Z., et al., Potential demonstrations of “hot spots” presence by adsorption-desorption of toluene vapor onto granular activated carbon under microwave radiation. Chemical Engineering Journal, 2017. 319: p. 191-199.
Yassin, M. M., et al., A systematic analysis of the dynamics of microwave- and conventionally-assisted swing adsorption on zeolite 13X and an activated carbon under post-combustion carbon capture conditions. Journal of Environmental Chemical Engineering, 2021. 9(6): p. 106835.
Yassin, M. M., et al., Effects of the heating source on the regeneration performance of different adsorbents under post-combustion carbon capture cyclic operations. A comparative analysis. Separation and Purification Technology, 2021. 276: p. 119326.

Yu, Q., et al., Stability of a benzyl amine based CO₂ capture adsorbent in view of regeneration strategies. Industrial & engineering chemistry research, 2017. 56(12): p. 3259-3269.
Zhang, Z., et al., Thermodynamics analysis of multi-stage temperature swing adsorption cycle for dilute CO₂ capture, enrichment and purification. Energy Conversion and Management, 2022. 265: p. 115794.

What is claimed is:

1. A method of desorption, the method comprising irradiating a fluidized solid sorbent having a captured composition adsorbed thereon with microwave irradiation, thereby desorbing at least a portion of the captured composition from the fluidized solid sorbent.

2. The method of claim 1, wherein the solid sorbent comprises zeolite, silica gel, activated carbon, a metal organic framework, or any combination thereof.

3. The method of claim 1, wherein the solid sorbent has a particle diameter of from about 175 μm to about 250 μm.

4. The method of claim 1, wherein the captured composition comprises CO₂.

5. The method of claim 1, further comprising fluidizing the solid sorbent in a fluidized bed reactor by flowing an inert fluid through the fluidized bed reactor.

6. The method of claim 5, wherein the inert fluid comprises N₂ gas.

7. The method of claim 5, wherein the inert fluid is flown through the fluidized bed reactor at a flow rate of from about 3 times to about 8 times a minimum fluidization velocity of the fluidized bed reactor comprising the solid sorbent.

8. The method of claim 1, wherein the microwave irradiation heats the fluidized solid sorbent to a temperature of from about 30° C. to about 100° C.

9. The method of claim 8, where the microwave irradiation has a power of from about 4 W to about 30 W.

10. The method of claim 1, wherein from about 50% to about 100% of the captured composition is desorbed.

11. The method of claim 1, wherein the method has an overall energy consumption of from about 2.5 MJ to about 30 MJ per kg of desorbed captured composition.

12. A method of carbon capture, the method comprising:
a) providing a solid sorbent in a fluidized bed reactor;
b) fluidizing the solid sorbent by flowing air comprising CO₂ through the fluidized bed reactor, wherein at least a portion of the CO₂ is adsorbed onto the solid sorbent;
c) refluidizing the solid sorbent having CO₂ adsorbed thereon by flowing an inert fluid through the fluidized bed reactor; and
d) irradiating the fluidized solid sorbent having CO₂ adsorbed thereon with microwave irradiation, thereby desorbing at least a portion of the captured composition from the fluidized solid sorbent.

13. The method of claim 12, wherein the solid sorbent comprises zeolite, silica gel, activated carbon, a metal organic framework, or any combination thereof.

14. The method of claim 12, wherein the solid sorbent has a particle diameter of from about 175 μm to about 250 μm.

15. The method of claim 12, wherein the air comprising CO₂ is flown through the fluidized bed reactor at a flow rate of from about 3 times to about 8 times a minimum fluidization velocity of the fluidized bed reactor with the solid sorbent.

16. The method of claim 12, wherein the adsorbed CO₂ has a concentration of from about 0.2 mmol to about 1.5 mmol per g of solid sorbent.

17. The method of claim 12, wherein the inert fluid comprises N₂ gas.

18. The method of claim 12, wherein the inert fluid is flown through the fluidized bed reactor at a flow rate of from about 3 times to about 8 times a minimum fluidization velocity of the fluidized bed reactor with the solid sorbent.

19. The method of claim 12, wherein the microwave irradiation heats the fluidized solid sorbent to a temperature of from about 30° C. to about 100° C.

20. The method of claim 19, where the microwave irradiation has a power of from about 4 W to about 30 W.

21. The method of claim 12, wherein from about 50% to about 100% of the adsorbed CO₂ is desorbed.

22. The method of claim 12, wherein the method has an overall energy consumption of from about 2.5 MJ to about 30 MJ per kg of desorbed CO₂.
